(19) United States
(12) Patent Application Publication
(10) Pub. No.: US 2013/0084413 A1
(43) Pub. Date: Apr. 4, 2013

(54) ANTI-FATIGUE MAT WITH REMOVABLE RESILIENT CUSHIONING MEMBER

(71) Applicant: LET'S GEL INCORPORATED, Austin, TX (US)

(72) Inventors: Robert L. McMahan, Cedar Park, TX (US); John P. Busch, Austin, TX (US); Ira L. Rush, Austin, TX (US); Scott D. Robertson, Austin, TX (US); Derric C. Hobbs, Austin, TX (US)

(73) Assignee: LET'S GEL INCORPORATED, Austin, TX (US)

(21) Appl. No.: 13/627,398

(22) Filed: Sep. 26, 2012

Related U.S. Application Data
(60) Provisional application No. 61/645,016, filed on May 9, 2012.
(60) Provisional application No. 61/543,305, filed on Oct. 4, 2011.

(51) Int. Cl. B32B 3/04; B32B 3/26; B32B 3/06; B32B 3/02; B32B 3/14; B32B 3/24

(52) U.S. Cl. 428/33; 428/68; 428/138; 428/71

(57) ABSTRACT

An anti-fatigue mat provides a “dual mode” feature wherein the anti-fatigue mat includes a resilient cushioning member that may be removed to enable cleaning of the remainder of the mat and/or the resilient cushioning member. The anti-fatigue mat includes a wear element having a wear surface on which a user may stand. The resilient cushioning member is situated adjacent the wear element in a receiver that is attached to the wear element. The receiver receives the resilient cushioning member via an aperture through which the resilient cushioning member may be installed and removed. The receiver may include multiple apertures to facilitate installation and removal of the resilient cushioning member. The anti-fatigue mat also provides a “dual friction” feature wherein the interior surface of the wear element may exhibit high friction with respect to the resilient cushioning member, and the receiver exhibits sufficiently high friction to reduce slippage on a floor.

### CROSS REFERENCE TO RELATED PATENT APPLICATIONS

This patent application claims priority to Provisional U.S. Patent Application Ser. No. 61/543,305, filed Oct. 4, 2011, inventors McMahan et al., entitled “ANTI-FATIGUE MAT WITH REMOVABLE RESILIENT CUSHIONING MEMBER”, which is incorporated herein by reference in its entirety.

This patent application further claims priority to Provisional U.S. Patent Application Ser. No. 61/645,016, filed May 9, 2012, inventors McMahan, et al., entitled “ANTI-FATIGUE MAT WITH REMOVABLE RESILIENT CUSHIONING MEMBER”, which is incorporated herein by reference in its entirety.

### BACKGROUND

Floor mats have been used for years to provide a cushion for the person standing on the mat. However, fatigue can still result when a person stands on a mat for an extended period of time. Persons who work standing up most of the day, such as cashiers, assembly line operators, people in home or commercial kitchens and many others still experience fatigue after standing on a conventional mat for long periods of time. Floor mats are often provided with non-slip surfaces to lessen slippage and to thus promote safety.

### BRIEF SUMMARY

In one embodiment, an anti-fatigue mat includes a wear element having a wear surface for supporting a user. The anti-fatigue mat also includes a resilient cushioning member. The anti-fatigue mat further includes a receiver, attached to the wear element, that receives the resilient element therein, the receiver including an aperture through which the resilient element may be installed and removed. In one embodiment, the receiver and the resilient cushioning member are parallel to the wear element.

In another embodiment, an anti-fatigue mat includes a wear element having a wear surface for supporting a user. The anti-fatigue mat also includes a resilient cushioning member. The anti-fatigue mat further includes a receiver, attached to the wear element, that receives the resilient cushioning member therein, the receiver including an aperture through which the resilient element may be installed and removed. In one embodiment, the wear element includes a first mat interior surface opposed to the wear surface, the first mat interior surface of the wear element exhibiting high friction that reduces the movement of the wear element relative to the resilient cushioning member when the resilient cushioning member is inside the receiver.

In another embodiment, an anti-fatigue mat includes a wear element including a wear surface for supporting a user. The anti-fatigue mat also includes a resilient cushioning member. The anti-fatigue mat further includes a receiver, attached to the wear element, that receives the resilient cushioning member therein, the receiver including an aperture through which the resilient element may be installed and removed. In one embodiment, the resilient cushioning member includes first and second resilient cushioning member sections, the first resilient cushioning member section including a first connector that connects with a second connector on the second resilient cushioning member section to hold the first resilient cushioning member section to the second resilient cushioning member section.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1A is a perspective view of one embodiment of the disclosed anti-fatigue mat that includes a receiver for a resilient cushioning member, wherein the receiver includes non-overlapping receiver sections.

FIG. 1B is perspective view of the wear surface of the anti-fatigue mat of FIG. 1.

FIG. 1C is a perspective view of the resilient cushioning member of the disclosed anti-fatigue mat.

FIG. 1D is a perspective view of a resilient cushioning member employing gel pads bonded to a flexible sheet.

FIGS. 1E-1H are cross sections different resilient cushioning members that may be used as the resilient cushioning member of the disclosed anti-fatigue mat.

FIG. 1I is a perspective view of an embodiment of an assembled anti-fatigue mat that includes a receiver.

FIG. 1J is a perspective view of another embodiment of an assembled anti-fatigue mat that includes a receiver that extends more closely to the edge of the mat than the mat of FIG. 1I.

FIG. 2A is a perspective view of another embodiment of the disclosed anti-fatigue mat that includes a receiver for a resilient cushioning member, wherein the receiver includes overlapping receiver sections.

FIG. 2B is a perspective view of the anti-fatigue mat of FIG. 2A showing the resilient cushioning member partially installed.

FIG. 2C is a perspective view of the anti-fatigue mat of FIG. 2A showing the resilient cushioning member fully installed.

FIG. 2D is a cutaway perspective view the anti-fatigue mat of FIG. 2A showing the resilient cushioning member fully installed and with one receiver section raised by hand to make the resilient cushioning member more visible.

FIG. 3A is a cross sectional view of the disclosed anti-fatigue mat with a resilient cushioning member installed therein.

FIG. 3B is a cross sectional view of the disclosed anti-fatigue mat with a resilient cushioning member removed.

FIG. 3C is a perspective view of a resilient cushioning member that the disclosed anti-fatigue mat may employ.

FIG. 3D is a plan view of the receiver side of one embodiment of the disclosed anti-fatigue mat.

FIG. 3E is a perspective view of one embodiment of the disclosed anti-fatigue mat after assembly.

FIG. 4A is a perspective view of the receiver side of one embodiment of the disclosed anti-fatigue mat.

FIG. 4B is a plan view of the receiver side of the embodiment of the disclosed anti-fatigue mat shown in FIG. 4A.

FIG. 5A is a perspective view of the receiver side of another embodiment of the disclosed anti-fatigue mat.

FIG. 5B is a plan view of the receiver side of the embodiment of the disclosed anti-fatigue mat shown in FIG. 5A.

FIG. 6A is a plan view of a die-cut resilient cushioning member that includes multiple resilient cushioning member sections connected by interlocking connectors in one embodiment of the disclosed anti-fatigue mat.

FIG. 6B is a plan view of the disclosed anti-fatigue mat after installation of the resilient cushioning member of FIG. 6A in a receiver that includes openings to allow access to the interlocking connectors of the resilient cushioning member.

FIG. 6C is a close-up view a portion of the anti-fatigue mat of FIG. 6B that depicts overlap between adjacent receiver sections.

FIG. 7A is a perspective view of a molded resilient cushioning member that includes multiple resilient cushioning member sections connected by interlocking connectors in one embodiment of the disclosed anti-fatigue mat.

FIG. 7B is a close-up view of a portion of the resilient cushioning member of FIG. 7A that depicts the interlocking connectors between adjacent resilient cushioning member sections.

### DETAILED DESCRIPTION

Anti-fatigue cushioned mats may be fabricated as rubber or vinyl mats that include a resilient layer or cushion. Advanced anti-fatigue mats may include one or more resilient layers of gel material. However, both of these types of anti-fatigue mats may not be machine washable. The disclosed anti-fatigue mat includes a resilient cushioning member that may be removed to enable the remainder of the mat to be easily cleaned. In one embodiment, removal of the resilient cushioning member also enables easy cleaning of the resilient cushioning member itself. The anti-fatigue mat includes a wear element having a wear surface on which a user may stand. The wear element may support the user in contact therewith. In one embodiment, the resilient cushioning member is situated adjacent the wear element in a receiver that holds the resilient cushioning member to the wear element. The receiver receives the resilient cushioning member via an aperture through which the resilient element may be installed and removed. In one embodiment, the wear element may be visually attractive textile.

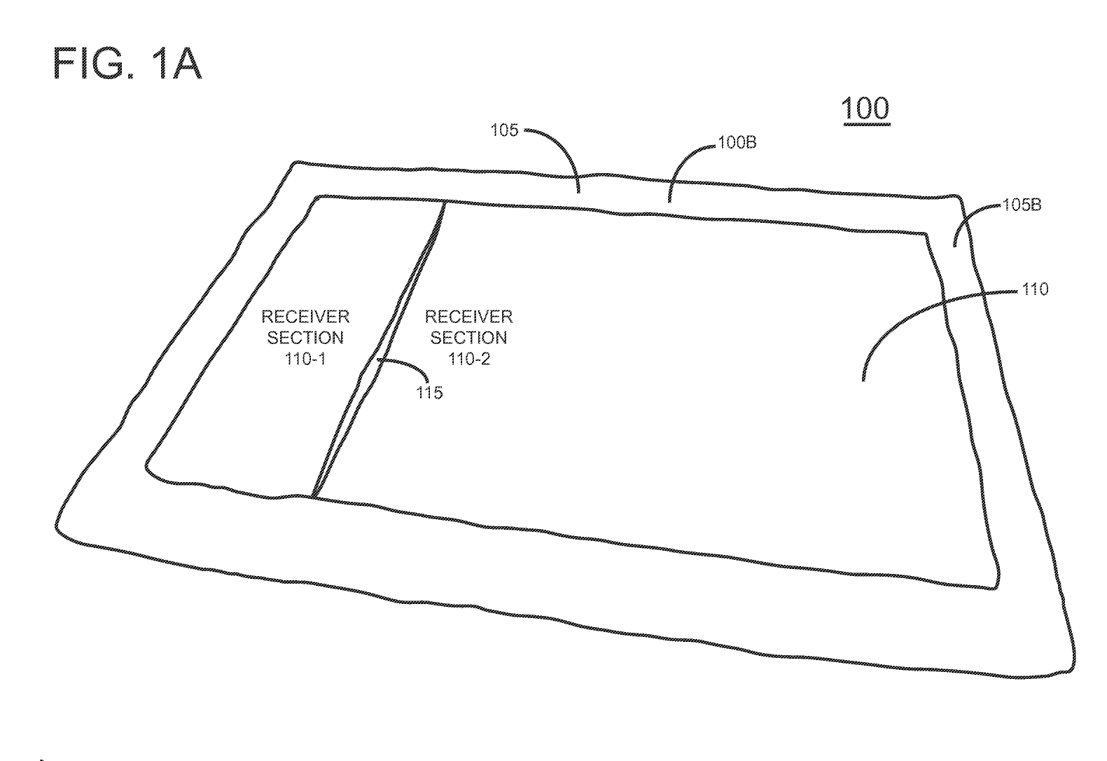

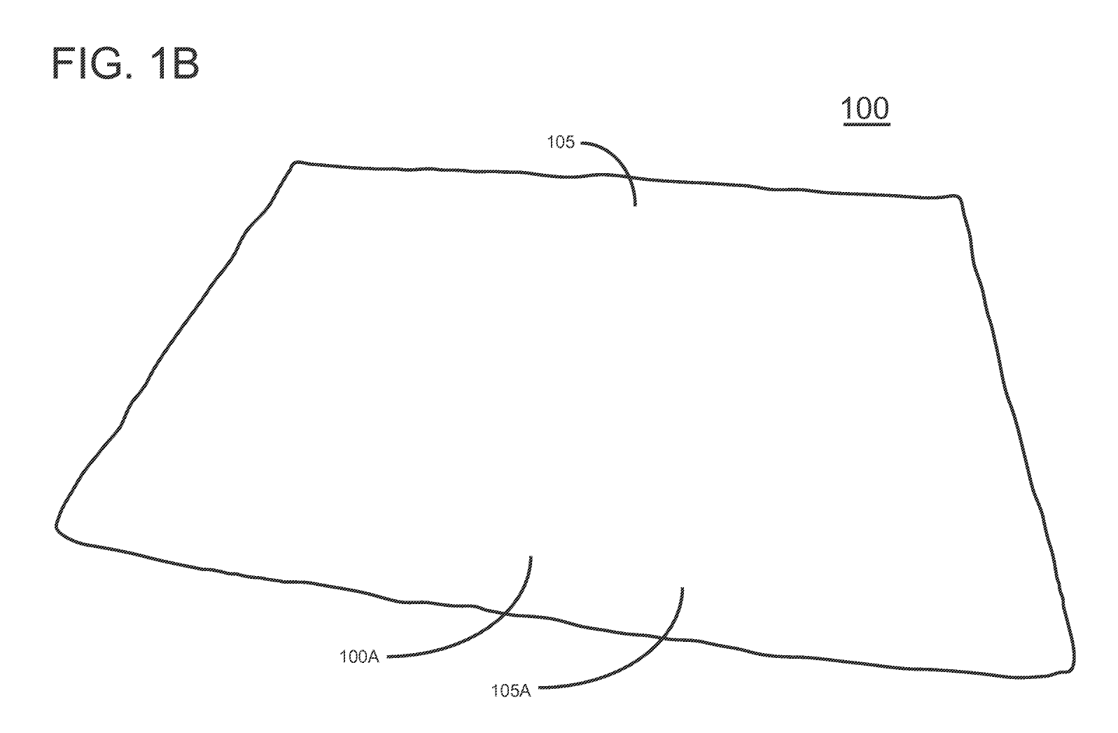

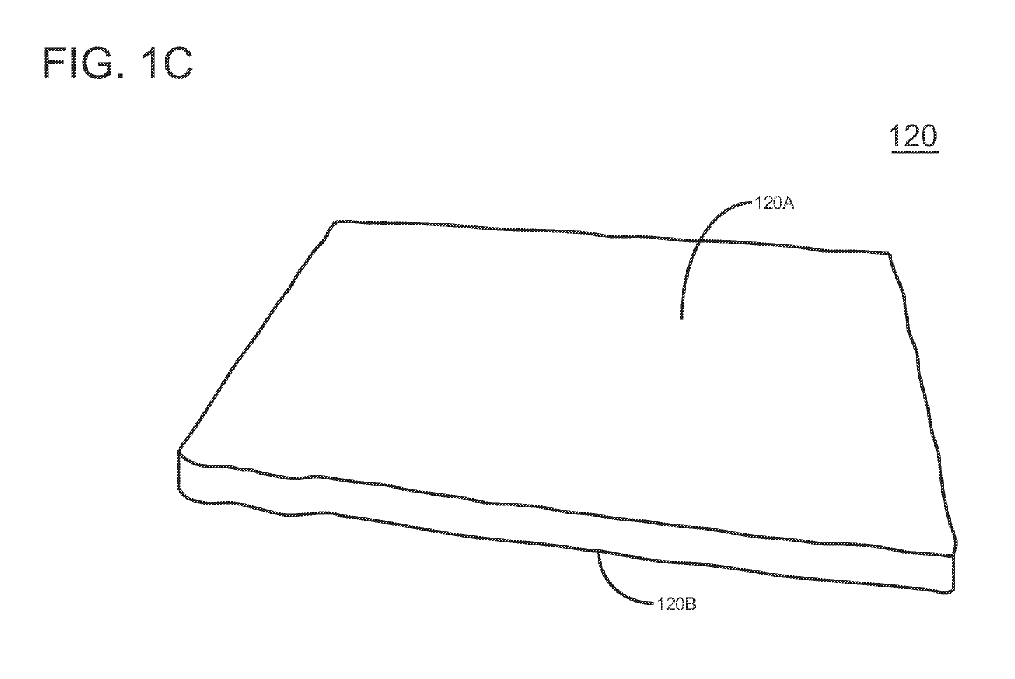

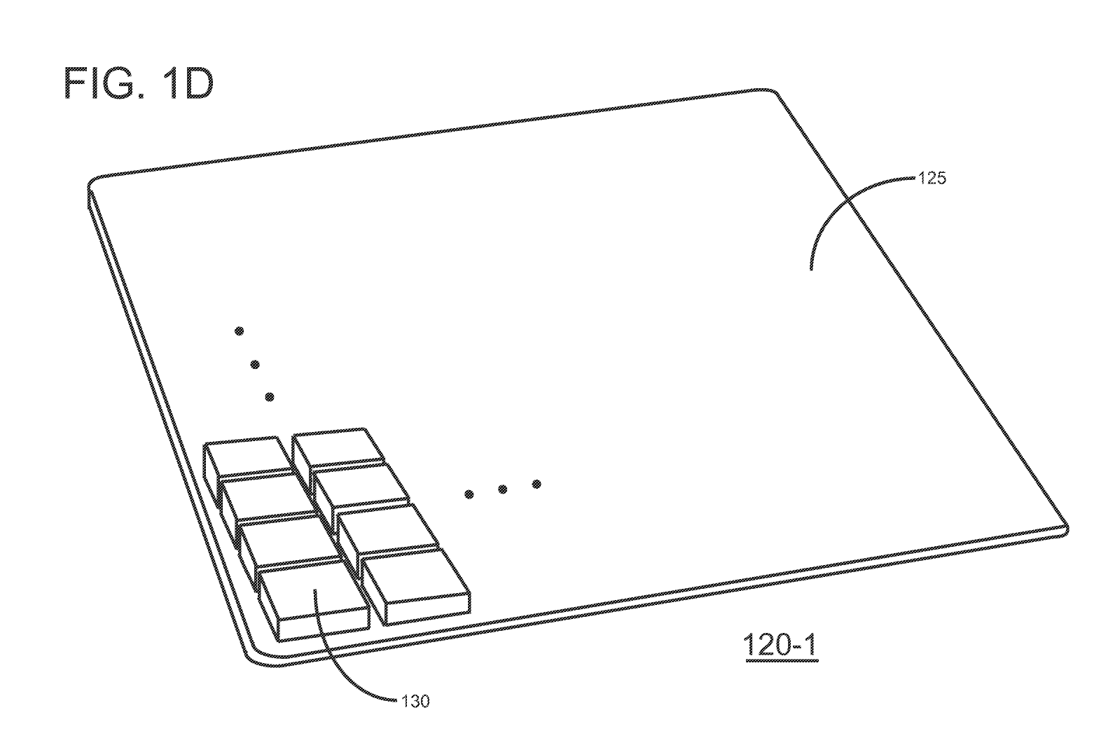

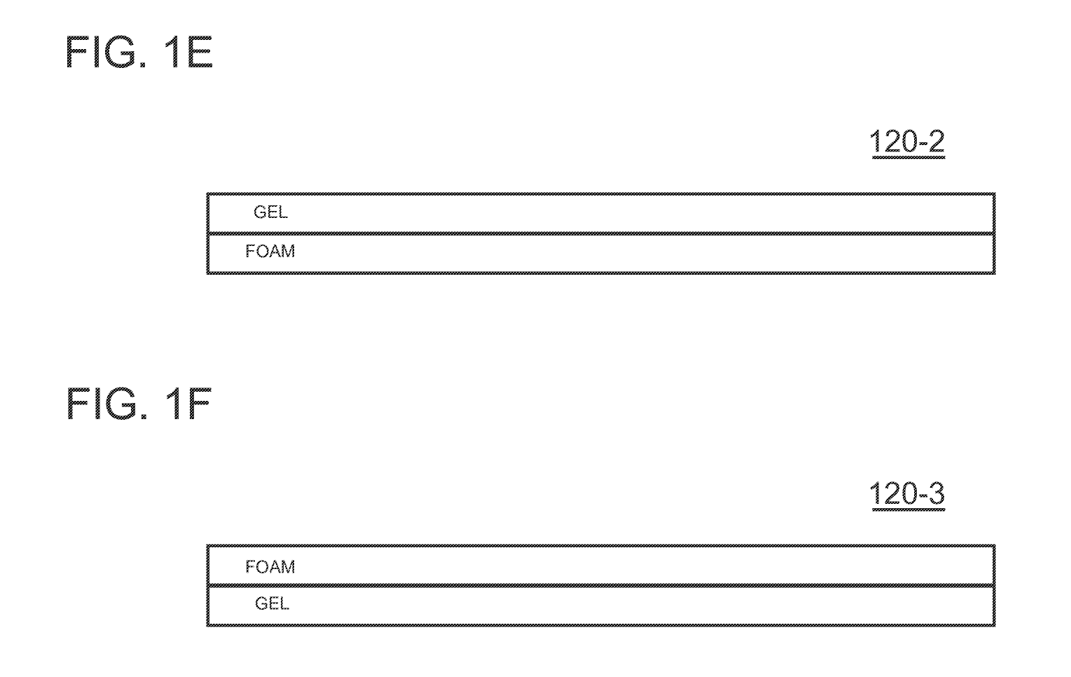

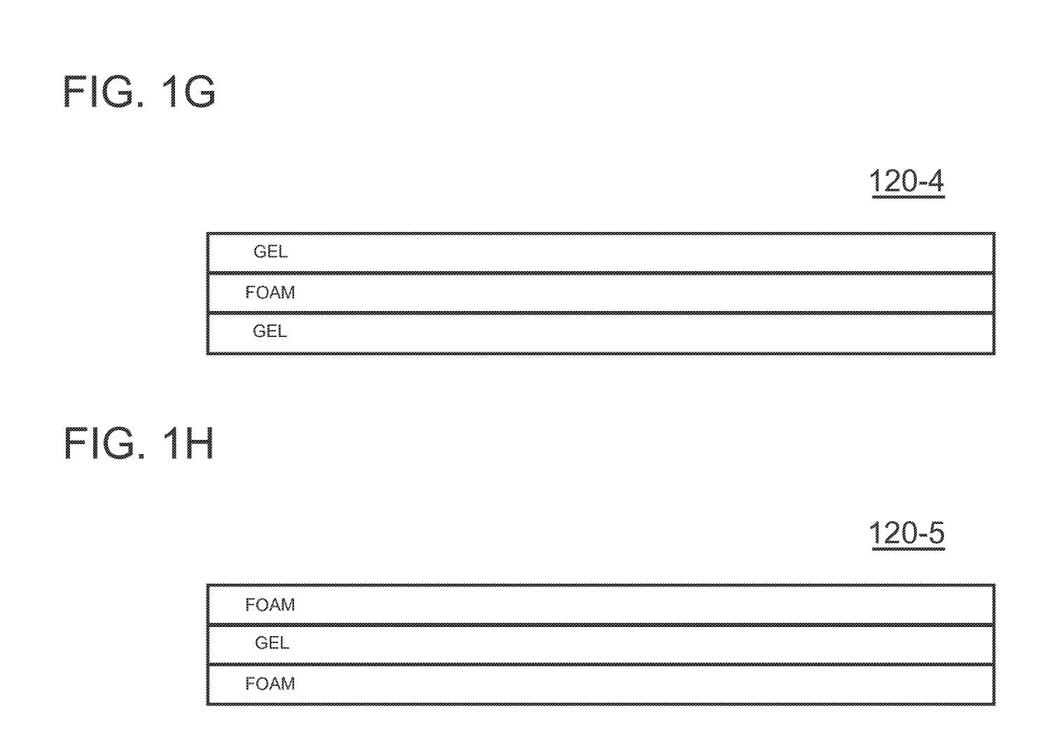

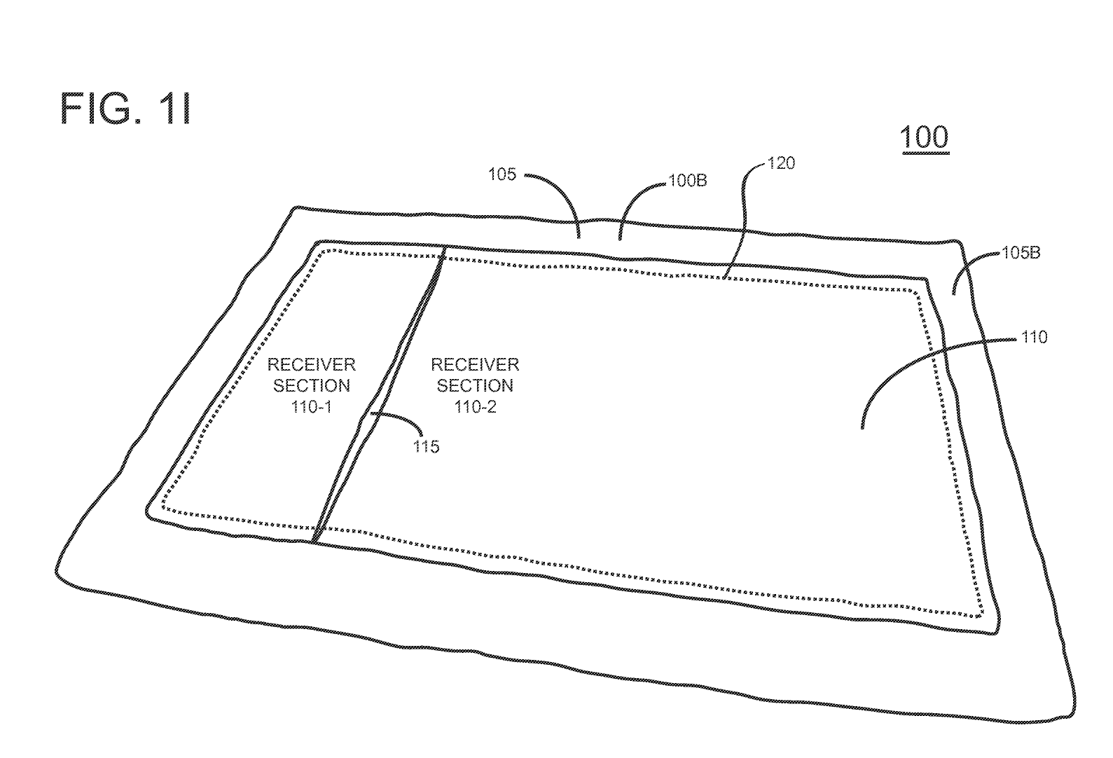

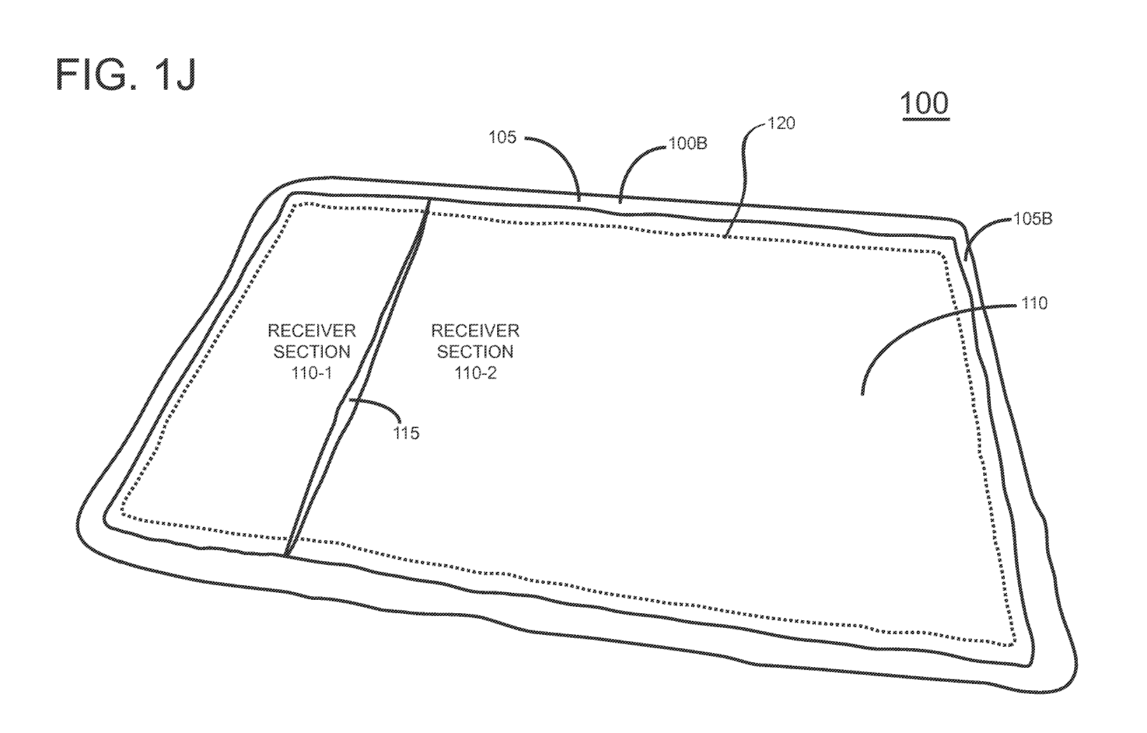

FIG. 1A shows one embodiment of the disclosed anti-fatigue mat 100. Anti-fatigue mat 100 includes opposed top and bottom surfaces 100A and 1008, respectively, of which bottom surface 100B is shown in this figure. Anti-fatigue mat 100 includes a wear element 105 that may be fabricated of material generally acceptable as material for rugs and carpeting, such as a flexible textile material, for example. FIG. 1A depicts the bottom of the wear element 105 in this particular view. Wear element 105 includes opposed top and bottom surfaces, namely top surface 105A and bottom surface 105B, of which bottom surface 105B is depicted in FIG. 1A. Wear element 105 may be a textile that exhibits one or more of a variety of colors, textures and yarns. Wear element 105 may be customizable, durable, visually attractive and washable.

In this particular embodiment, a resilient cushioning member receiver 110 is attached to the bottom surface 105B of the wear element 105 to capture and hold a flexible resilient cushioning member (not shown) inside resilient cushioning member receiver 110. The receiver 110 may be sewn or otherwise attached to the wear element 105. For example, receiver 110 may be attached to wear element 105 via hook and loop fasteners. The receiver 110 may be formed as an integral part of the wear element 105. The receiver 110 of FIG. 1A includes receiver section 110-1 and receiver section 110-2 with an aperture 115 situated between these two receiver sections, as illustrated. In this particular embodiment, receiver sections 110-1 and 110-2 are non-overlapping. In other embodiment, receiver sections 110-1 and 110-2 may overlap at aperture 115. The user or other entity may install the resilient cushioning member in receiver 110 of anti-fatigue mat 100 by inserting the resilient cushioning member through aperture 115. The resilient cushioning member is also removable through aperture 115 when it is time to wash, or otherwise clean, the wear element 105.

FIG. 1B shows the top 100A of the wear element 105 of the anti-fatigue mat 100. The top 100A of the anti-fatigue mat 100 provides a wear surface 105A on which the user stands or which otherwise contacts the user. The wear surface 105A of the mat 100 may be stylishly decorated with attractive patterns and/or colors that would appeal to consumers, businesses and others.

FIG. 1C shows a representation of the resilient cushioning member 120 that may be installed in the receiver 110 of the wear element 105. The resilient cushioning member 120 is fabricated from flexible resilient material such as foam, gel or other resilient material that provides the user comfort when the user stands on the anti-fatigue mat. In one embodiment, the resilient cushioning member may be fabricated from both gel and foam. For example, in such an embodiment, the resilient cushioning member may include a layer of gel and a layer of foam sandwiched together. In another embodiment, the resilient cushioning member may include a layer of gel sandwiched between two foam layers. The top 120A and/or the bottom 120B of the resilient cushioning member 120 may include non-slip surfaces to arrest, minimize or reduce slippage between the resilient cushioning member 120 and other parts of the mat 100 in contact with the resilient cushioning member 120. This non-slip surface may also be referred to as an anti-slip surface.

FIG. 1D shows another cushioning member 120-1 that may be employed as the resilient cushioning member 120. The resilient cushioning member 120-1 of FIG. 1D includes a flexible sheet 125 of material such as foam, polyurethane or other flexible material to which multiple gel pads 130 are bonded or otherwise attached. Resilient cushioning member 120-1 includes gel pads 130 arranged in columns and rows as shown. The gel pads 130 depicted exhibit a square geometry, but gel pads exhibiting other geometries such as circular, rectangular, elliptical, and so forth may be employed as well. For simplicity, FIG. 1D shows 2 columns and 4 rows of gel pads 130. However, the ellipses in FIG. 1D indicate that the entire surface of the flexible sheet 125 may be populated with gel pads to provide a cushioning effect to the mat employing this resilient cushioning member. In another embodiment, a substantially continuous layer of gel may replace the gel pads 130.

FIG. 1E shows an alternative embodiment of a resilient cushioning member 120-2 that may be used as resilient cushioning member 120. Resilient cushioning member 120-2 is a sandwich that includes a gel layer on a foam layer. In this embodiment, the gel layer of resilient cushioning member 120-2 may face the bottom surface 105B of wear element 105 when resilient cushioning member 120-2 is inserted in receiver 110. In this manner, resilient cushioning member 120-2 exhibits multiple durometers.

FIG. 1F shows another alternative embodiment of a resilient cushioning member 120-3 that may be used as resilient cushioning member 120. Resilient cushioning member 120-3 is a sandwich that includes a foam layer on a gel layer. In this embodiment, the foam layer of resilient cushioning member 120-3 may face the bottom surface 105B of wear element 105 when resilient cushioning member 120-3 is inserted in receiver 110. In this manner, resilient cushioning member 120-3 exhibits multiple durometers.

FIG. 1G shows yet another alternative embodiment of a resilient cushioning member 120-4 that may be used as resilient cushioning member 120. Resilient cushioning member 120-4 is a sandwich that includes a gel layer on a foam layer on a gel layer. In this embodiment, one of the two gel layers of resilient cushioning member 120-4 may face the bottom surface 1058 of wear element 105 when resilient cushioning member 120-4 is inserted in receiver 110. In this manner, resilient cushioning member 120-4 exhibits multiple durometers.

FIG. 1H shows still another alternative embodiment of a resilient cushioning member 120-5 that may be used as resilient cushioning member 120. Resilient cushioning member 120-5 is a sandwich that includes a foam layer on a gel layer on a foam layer. In this embodiment, one of the two foam layers of resilient cushioning member 120-5 may face the bottom surface 1058 of wear element 105 when resilient cushioning member 120-5 is inserted in receiver 110. In this manner, resilient cushioning member 120-5 exhibits multiple durometers.

FIG. 1I shows the bottom 105B of the wear element 105 after installation of the resilient cushioning member 120 through the aperture 115 between receiver sections 110-1 and 110-2. The resilient cushioning member 120 is shown in dotted lines to make it visible even though it is captured inside the receiver 110 and would otherwise not be clearly visible. In one embodiment, receiver sections 110-1 and 110-2 may include respective external non-slip surfaces to assist the mat 100 in remaining stationary when placed on a surface for use. The portion of the wear element 105 not occupied by the receiver 110 may also include such external non-slip surfaces. In other words, the portion of the wear element 105 shown in FIG. 1D between the receiver 110 and the peripheral edge of mat 100 may be outfitted with non-slip material. FIG. 1J shows an alternative embodiment of anti-fatigue mat 100 wherein the receiver 110 extends more closely to the peripheral edge of mat 100 than shown for the mat of FIG. 1I. In the embodiments illustrated in FIGS. 1H and 1I above, there is no overlap between receiver sections 110-1 and 110-2. Other embodiments are contemplated wherein the receiver sections do overlap, as discussed in more detail below.

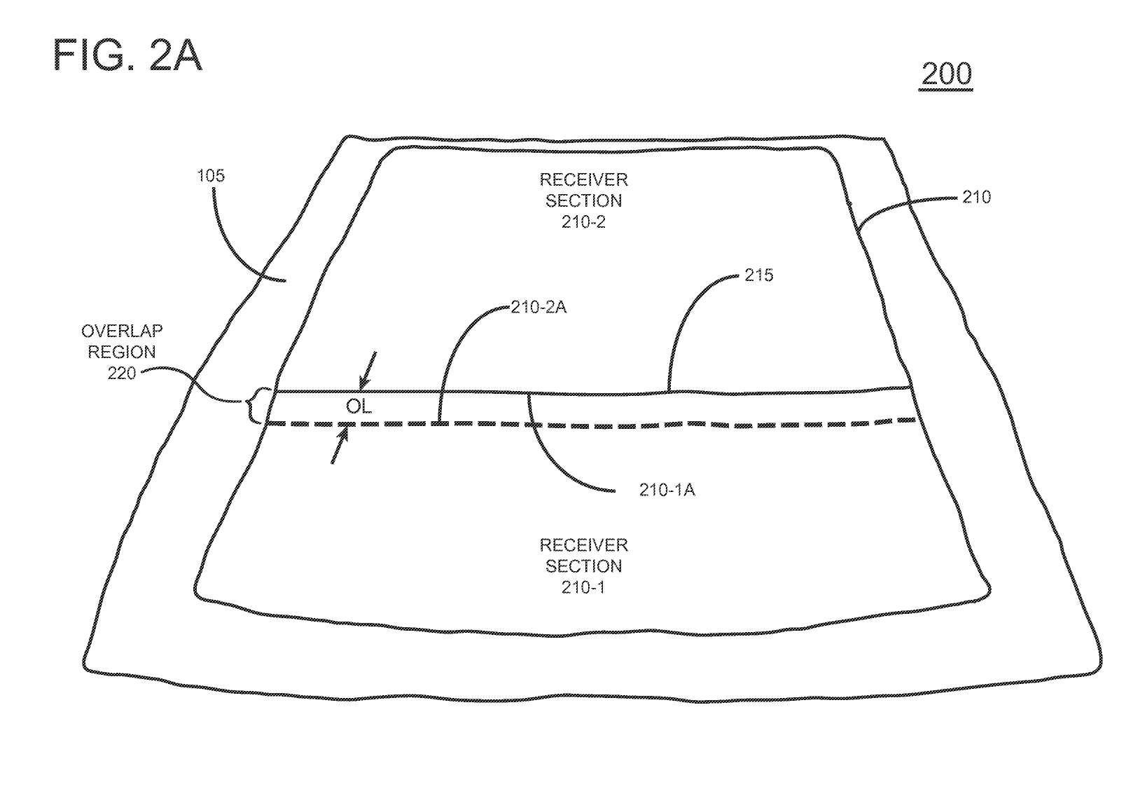

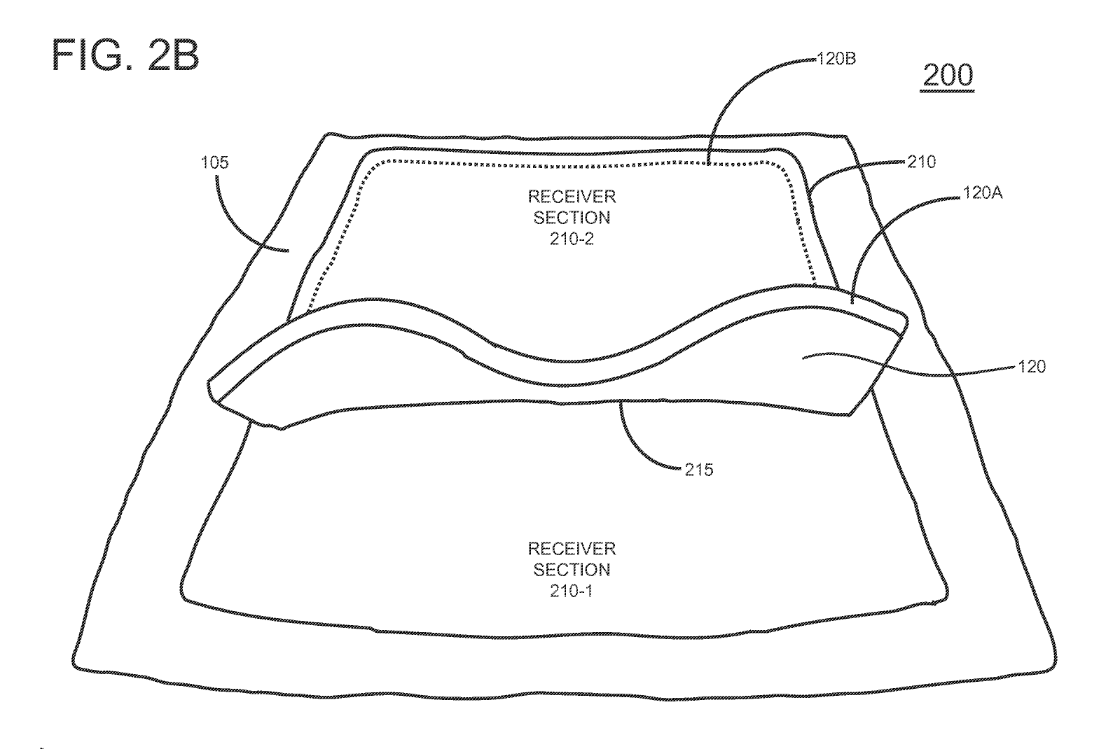

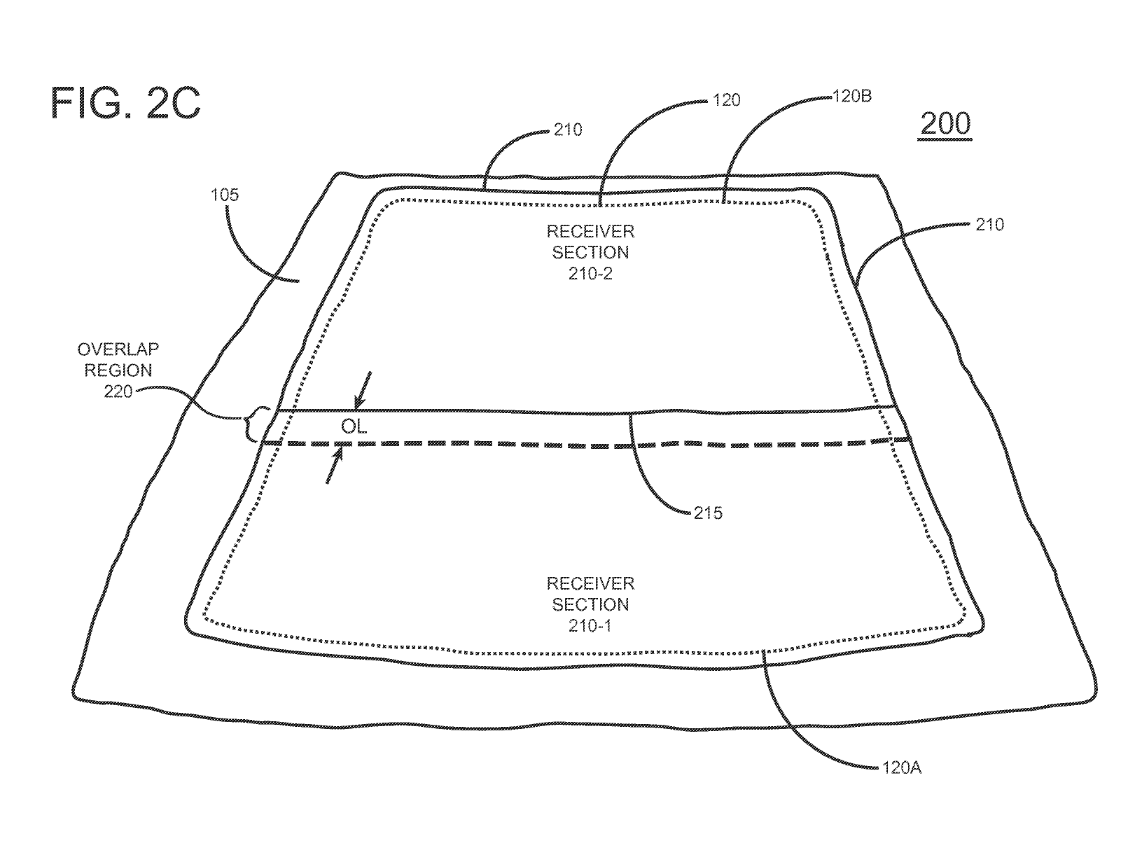

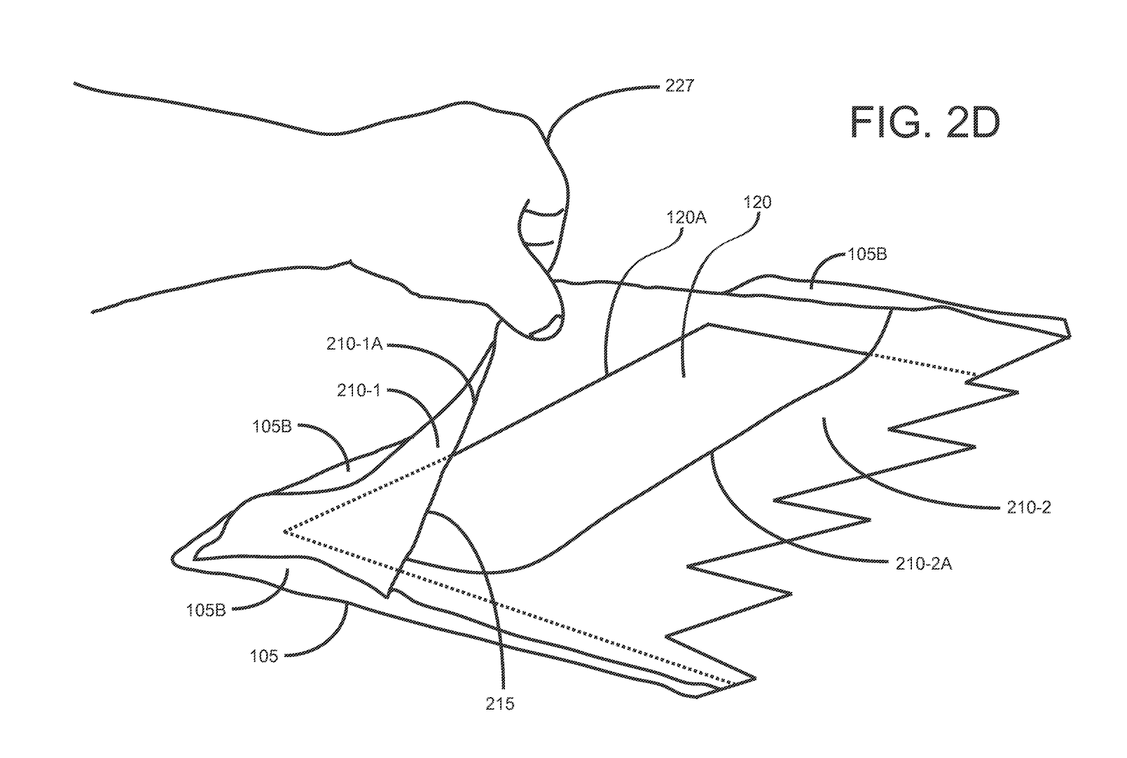

FIG. 2A shows another embodiment of the disclosed anti-fatigue mat as mat 200. Mat 200 of FIG. 2A includes elements in common with mat 100 of FIG. 1A. Like numbers indicate like elements when comparing mat 200 of FIG. 2A with mat 100 of FIG. 1A. Mat 200 includes a receiver 210 with receiver sections 210-1 and 210-2. As discussed in more detail below, the resilient cushioning member 120 will be installed in receiver 210 by moving resilient cushioning member 120 through aperture 215 in empty receiver 210. Receiver sections 210-1 and 210-2 include respective ends 210-1A and 210-2A that overlap one another to form an overlap region 220. Overlap region 220 is located adjacent aperture 215. Overlap region 220 may employ an overlap distance, OL, that exhibits a value of approximately 0 cm to 10 cm depending on the particular application. The overlap distance, OL, may exhibit values of greater than approximately 10 cm such as 20 cm or more, depending on the particular application. Generally, the overlap distance, OL, should not be so large that it becomes excessively difficult to insert resilient cushioning member 120 through aperture 215 and to remove resilient cushioning member 120 from aperture 215.

In a manner similar to the anti-fatigue mat 100 of FIG. 1A, the receiver 210 is situated on the bottom of the wear element 105 and may be integrally formed as a part of the wear element 105. The receiver 210 may alternatively be attached to the remainder of the wear element 105 by sewing adjacent the peripheral edge of the receiver 210, or otherwise attaching receiver 210 to wear element 105. As discussed above, the receiver 210 of the wear element 105 includes an overlap region 220 where receiver section 210-1 overlaps above receiver section 210-2 adjacent the aperture 215 therebetween. The dashed line at the overlap region 220 indicates that the end 210-2A of receiver section 210-2 facing receiver section 210-1 passes below a portion of receiver section 210-1. In this particular embodiment, overlap region 220 is formed by situating receiver section end 210-1A above receiver section end 210-2A as shown. In an alternative embodiment, this relationship may be inverted such that overlap region 220 is formed by situating receiver section end 210-1A below receiver section 210-2A.

FIG. 2B shows the anti-fatigue mat 200 of FIG. 2A during the process of installing or removing the resilient cushioning member 120 in the receiver 210 of the mat 200. Resilient cushioning member 120 includes opposed ends 120A and 120B as shown. To install the resilient cushioning member 120, the user or other entity first inserts the resilient cushioning member 120 into receiver section 210-2 by passing the resilient cushioning member end 120B through the aperture 215 between the receiver sections 210-1 and 210-2. In FIG. 2B, the partially installed resilient cushioning member 120 is indicated by dotted lines to show that the resilient cushioning member 120 is situated within receiver section 210-2. A portion of the resilient cushioning member 120 including resilient cushioning member end 120A extends outside of the receiver 210 in FIG. 2A because the resilient cushioning member 120 is not yet completely installed in the receiver 210.

Subsequently, the user or other entity places the remainder of the resilient cushioning member 120 including resilient cushioning member end 120A inside receiver section 210-1 such that the fully assembled anti-fatigue mat 200 appears as illustrated in FIG. 2C. The dotted line in FIG. 2C indicates the peripheral edge of the resilient cushioning member 120 within the receiver 210. In one embodiment, receiver sections 210-1 and 210-2 may include respective non-slip surfaces to assist the mat 200 in remaining stationary when placed on a surface for use. The portion of the wear element 205 not occupied by the receiver 210 may also include such non-slip surfaces.

To remove the resilient cushioning member 120 from the mat 200 for cleaning of the wear element 105 and/or cleaning of the resilient cushioning member 120 itself or for other purposes, the user reverses the installation procedure described above and removes the resilient cushioning member 120 by extracting it through the aperture 215. For example, as shown in FIG. 2D, the user 227 may grasp receiver section 210-1 adjacent the aperture 215 and pull upward by hand to reveal the resilient cushioning member 120. The user 227 may extract the end 120A of the resilient cushioning member 120 under receiver section 210-1 first and then pull to remove the remaining portion of the resilient cushioning member 120 under receiver section 210-2 through the aperture 215. The receiver 210 of mat 200 is now again empty as shown above with reference to FIG. 2A. With the resilient cushioning member 120 thus removed, the wear element 105 is now easily washed, laundered or otherwise cleaned.

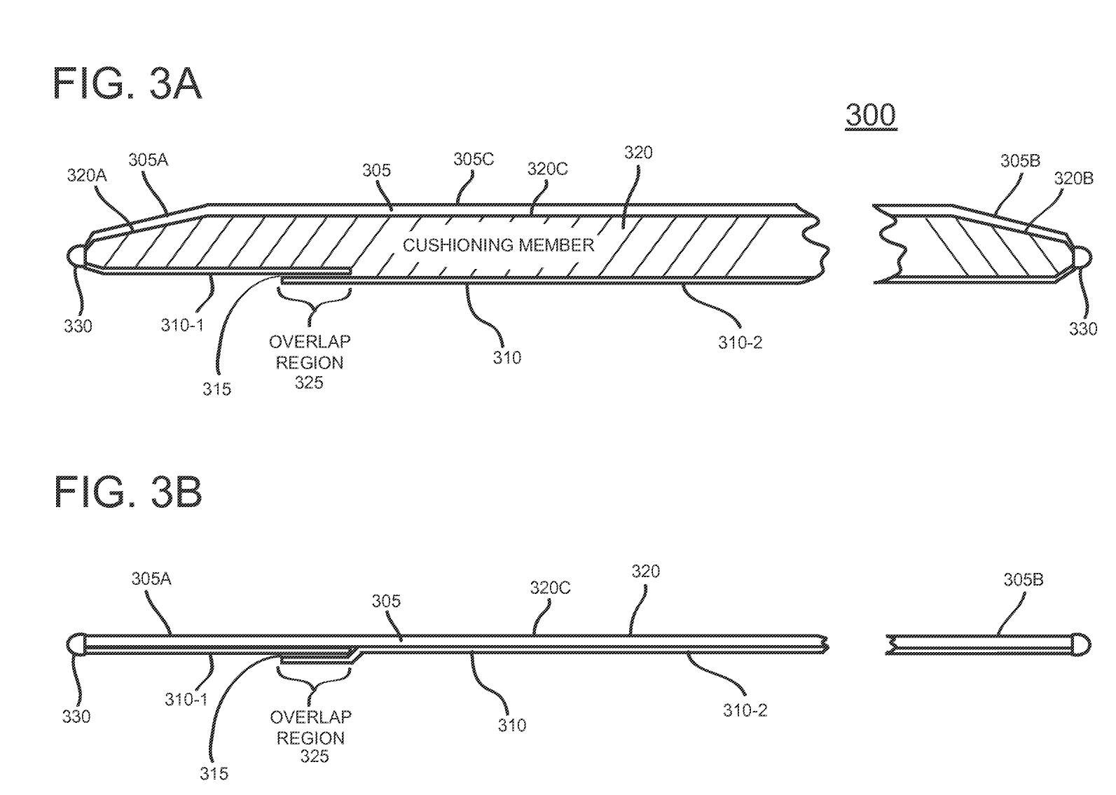

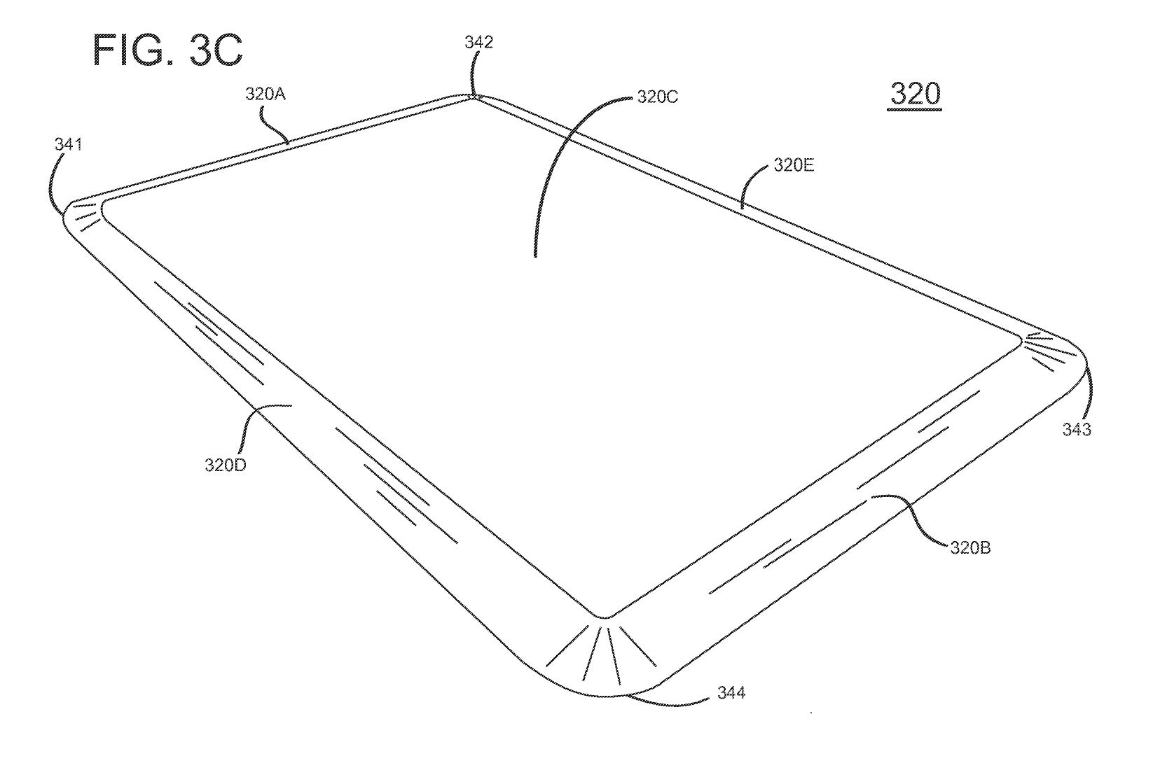

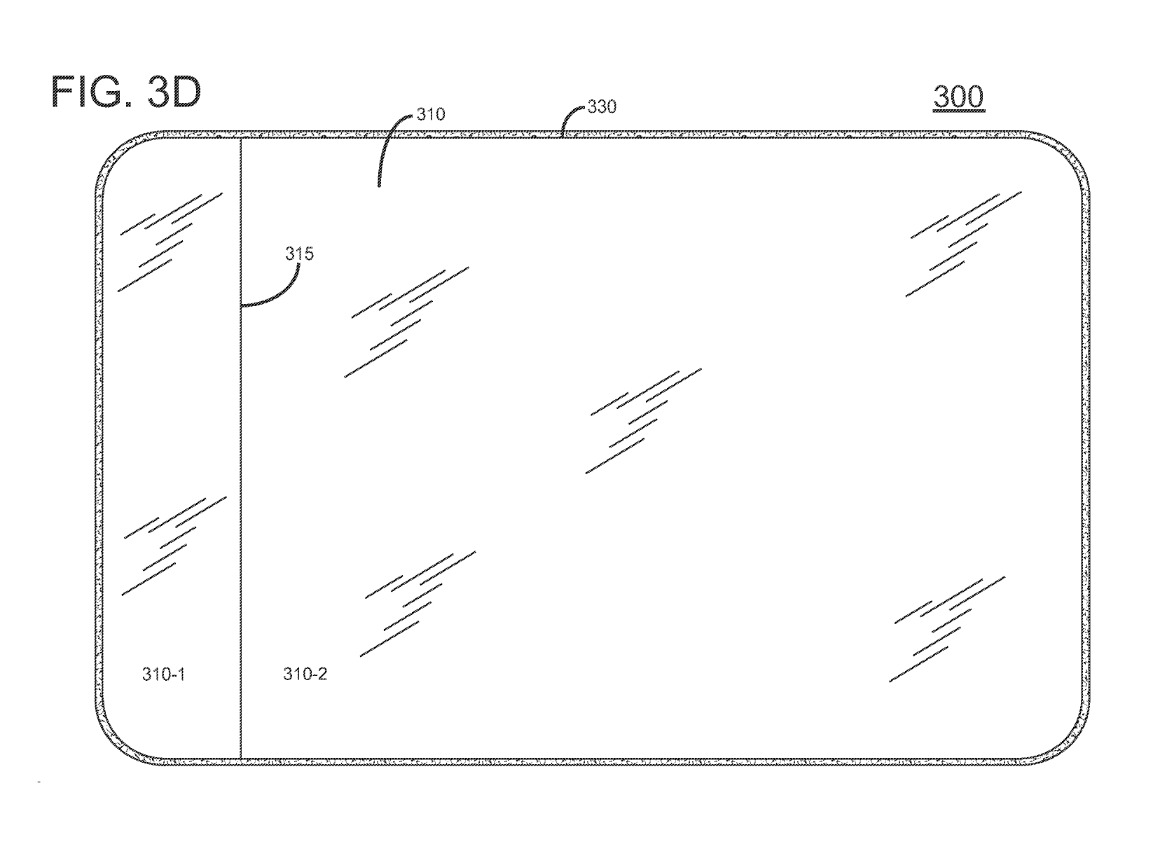

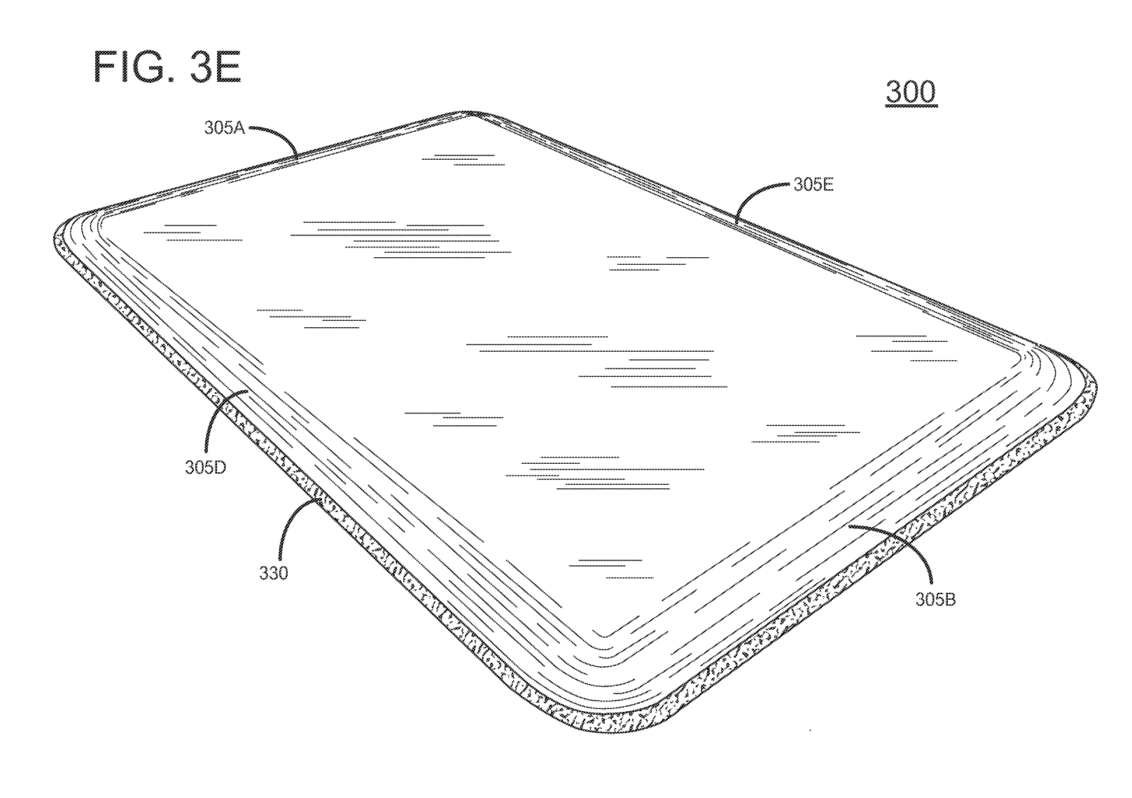

FIG. 3A shows a cross sectional view of an anti-fatigue mat 300. Anti-fatigue mat 300 of FIG. 3A includes several elements that are similar to like elements of anti-fatigue mat 100 of FIG. 1 and anti-fatigue mat 200 of FIG. 2. Anti-fatigue mat 300 includes a wear element 305 similar to wear element 105 of mat 100 and mat 200. Anti-fatigue mat 300 includes a receiver 310 with receiver sections 310-1 and 310-2 arranged in overlapping fashion as shown in FIG. 3A. Receiver 310 includes an overlap region (OL) 325. In this particular embodiment, the portion of receiver section 310-1 that overlaps receiver section 310-2 is above receiver section 310-2 at overlap region 325. In another embodiment, the portion of receiver section 310-1 that overlaps receiver section 310-2 may be below receiver section 310-2 at overlap region 325.

Receiver 310 includes an aperture 315 at overlap region 325 through which a resilient cushioning member 320 may pass during installation of resilient cushioning member 320 in mat 300 or during removal of resilient cushioning member 320 from mat 300. Resilient cushioning member 320 may be fabricated from the same materials as resilient cushioning member 120 of mat 100 and mat 200. Resilient cushioning member 320 includes ramps at its peripheral edges such as ramps 320A and 320B shown in FIG. 3A. In this particular embodiment, resilient cushioning member 320 includes a substantially flat region 320C between ramps 320A and 320B. When the user installs resilient cushioning member 320 in receiver 310 of mat 300 via aperture 315, wear element 305 conforms to the geometry of the ramps of resilient cushioning member 320 such as ramps 320A and 320B as well as substantially flat region 320C. In this manner, resilient cushioning member 320 causes wear element 305 to exhibit ramps such as ramp 305A, ramp 305B and a substantially flat region 305C that correspond respectively to ramp 320A, ramp 320B and substantially flat region 320C of resilient cushioning member 320. In other words, the geometry of wear element 305 follows the geometry of the resilient cushioning member 320 below wear element 305. As seen in FIG. 3C, one embodiment of resilient cushioning member 320 includes ramps 320A, 320B, 320D and 320E. When the user or other entity installs this resilient cushioning member 320 into anti-fatigue mat 300, this causes the geometry of the wear element 305 of mat 300 to conform to the geometry of the resilient cushioning member 320 therein, as shown in FIG. 3E. As seen in FIG. 3E, the geometry of anti-fatigue mat 300 now includes wear element ramps 305A, 305B, 305D and 305E above the now unseen resilient cushioning member ramps 320A, 320B, 32D and 320E, respectively.

Returning to FIG. 3A, it is noted that the cross-section of anti-fatigue mat 300 that FIG. 3A shows is a lengthwise cross-section. It should be understood however that a cross-section taken across the width of anti-fatigue mat 300 appears substantially the same as the cross-section shown in FIG. 3A. Ramps such as ramp 305A may thus appear on all four sides of anti-fatigue mat 300. It should be understood that the cutaway portion of anti-fatigue mat 300 on the right side of FIG. 3A indicates that the length or width of anti-fatigue mat 300 may assume different values rather than being limited to particular length and/or width values.

The peripheral edges of wear element 305 are sewn or otherwise connected to the adjacent peripheral edges of receiver 310 to hold receiver 310 to wear element 305. For example, anti-fatigue mat 300 may include a serge 330 that surrounds the peripheral edges of mat 300 to connect receiver 310 to wear element 305. Serge 330 provides a durable, attractive, high quality, washable edge attachment for anti-fatigue mat 300.

FIG. 3B shows anti-fatigue mat 300 with the resilient cushioning member 320 removed for cleaning or for use a as mat without a cushioning member. With resilient cushioning member 320 removed, ramps 320A and 320B now lay flat and aligned with substantially flat region 320C, as shown in FIG. 3B. Anti-fatigue mat 300 is thus a “dual mode” mat that is useable in one mode where resilient cushioning member 320 in installed in receiver 310, as shown in FIG. 3A, and another mode where resilient cushioning member 320 is removed from receiver 310, as shown in FIG. 3B. In other words, by virtue of this “dual mode” feature, anti-fatigue mat 300 is usable with or without resilient cushioning member 320 installed therein. Anti-fatigue mat 300 still functions with receiver 310 empty, although mat 300 does not provide as much resilience as when resilient cushioning member 320 is installed in receiver 310.

As described above, anti-fatigue mat 300 includes a textile wear element 305 and a non-slip receiver 310 that cooperate to capture resilient cushioning member 320. In actual practice, receiver 310 may include multiple receiver sections such as 310-1 and 310-2 that each exhibit non-slip properties. In this manner, slippage or movement of anti-fatigue mat 300 on a floor or other surface is prevented or decreased. In one embodiment, anti-fatigue mat 300 exhibits a “dual mode” feature that cooperates with a “dual-friction” feature to enable anti-fatigue mat 300 to be used with or without resilient cushioning member 320. In one embodiment, the “dual friction” feature refers to 1) the exterior surface of receiver 310 exhibiting sufficient friction with respect to the floor to reduce slippage between the mat and the floor, and 2) the interior surface of wear element 305 exhibiting sufficient friction with respect to the resilient cushioning member 320 to reduce slippage therebetween. The “dual friction” feature is explained in more detail below.

In one embodiment, resilient cushioning member 320 is a molded-foam cushion as distinguished from the cut-foam that resilient cushioning member 120 of FIG. 1C may employ. Molded-foam resilient cushioning member 320 is shaped to include functional lead-in ramps such as ramps 320A and 320B. This desirable lead-in feature may reduce tripping while also serving to fill the portions of receiver 310 adjacent the outer peripheral edges thereof, such as those portions of the mat adjacent serge 330. Filling receiver 310 in this manner may provide anti-fatigue mat 300 with a smart looking tight fit. In one embodiment, the angle of lead-in ramps such as ramps 320A and 320B with respect to the horizontal axis is within the range of approximately 18 degrees to approximately 20 degrees, although lead-in ramp angles outside of this range may also be employed depending on the particular application. For example, ramps exhibiting angles within the range of approximately 5 degrees to approximately 60 degrees may also perform acceptably as long as the angle is not so small that the lead in ramp consumes a substantial amount of the wear surface above or so large that a user may trip. As seen in FIG. 3C, the resilient cushioning member 320 may include rounded corners 341, 342, 343 and 344 that make it easier to insert the resilient cushioning member into the receiver and to extract the resilient cushioning member from the receiver.

As noted above, receiver 310 includes an opening or aperture 315 that receives resilient cushioning member 320 during installation of resilient cushioning member 320 in receiver 310. The receiver sections 310-1 and 310-2 overlap at overlap region 325. This overlap helps maintain tension on the bottom surface of mat 300, i.e. the bottom exterior surface of mat 300 that receiver 310 forms. This tension helps mat 300 to lay flatter than would otherwise be possible. More tension, i.e. increased overlap, allows aperture 315 to close tightly so mat 300 does not slip on a floor. While the mat will still function if there is no overlap, a mat wherein the receiver sections overlap is desirable so that the tensions of the interior and exterior surfaces of receiver 310 remain substantially even and consistent to enhance the aesthetics and functionality of the mat.

As described above, in one embodiment, anti-fatigue mat 300 employs a “dual mode” feature and a “dual friction” feature that cooperate to enhance mat performance. The “dual mode” feature enables use of anti-fatigue mat 300 with or without resilient cushioning member 320 installed therein. More particularly, anti-fatigue mat 300 may operate in a first mode when resilient cushioning member 320 is installed therein as shown in FIG. 3A, and may alternatively operate in a second mode when the resilient cushioning member 320 in not installed therein as shown in FIG. 3B.

Referring again to FIG. 3A, anti-fatigue mat 300 exhibits a “dual friction” feature. In one aspect of the “dual friction” feature, the exterior surface of receiver 310 is fabricated from high-traction, i.e. high friction, non-slip material. The high friction material of receiver 310 reduces mat slippage on a floor on other surface, and provides part of the “dual-friction” feature described above. In one embodiment, a surface exhibiting a static coefficient of friction greater than approximately 1.0 is considered to be “high friction”. In one embodiment, the static coefficient of friction should be sufficiently high that the non-slip surface holds the anti-fatigue mat in place on the floor or other surface where the anti-fatigue mat is used.

As another aspect of the “dual friction” feature, the interior surface of wear element 305 may include a high friction material that exhibits sufficient friction with respect to the adjacent resilient cushioning member 320 to keep wear element 305 from gathering or bunching as a user drags their foot across wear element 305. Such gathering or bunching in the wear element 305 would be unsightly and undesirable for the user aesthetically and functionally when mat 300 operates in the first mode with the resilient cushioning member 320 installed therein.

Moreover, when anti-fatigue mat 300 operates in the second mode wherein no resilient cushioning member 320 is installed inside mat 300 as shown in FIG. 3B, the high friction exhibited by the interior surface of wear element 305 relative to the friction of the interior surface of receiver 310 is sufficiently high to arrest relative movement between the wear element 305 and receiver 310 which contact one another in the second mode. This configuration enables the high friction exhibited by the interior surface of wear element 305 to stabilize mat 300 both with and without resilient cushioning member 120 installed in receiver 310. In this manner a “dual mode”, “dual friction” anti-fatigue mat 300 is provided. In a preferred embodiment, the high friction interior surface of wear element 305 cooperates with a low friction interior surface of receiver 310 to facilitate installation and removal of resilient cushioning member 320 from receiver 310.

In an alternative embodiment, the top surface of resilient cushioning member 320 may exhibit high friction to reduce movement of wear element 305 with respect to the top surface of resilient cushioning member 320. In that embodiment, the interior surface of wear element 305 need not exhibit high friction. In another embodiment, both the interior surface of wear element 305 and the top surface of resilient cushioning member may exhibit high friction.

In one embodiment, the interior surface of the receiver 310, i.e. the surface of receiver 310 that faces wear element 305, exhibits low friction relative to resilient cushioning member 320 to facilitate moving resilient cushioning member 320 into receiver 310 and removing resilient cushioning member 320 from receiver 310. For example, a lower-friction fabric backing may be applied to the interior surface of receiver 310. By lower-friction is meant a friction value that is less than the much higher friction value that the interior surface of wear element 305 exhibits. In one embodiment, the friction exhibited by the interior surface of receiver 310 is sufficiently low to enable resilient cushioning member 320 to slide over the interior surface of receiver 310 when the resilient cushioning member 320 is installed or removed. In one embodiment, the resilient cushioning member 320 and the receiver 310 are substantially parallel to the flat region 320C of wear member 305.

FIG. 3C is a top perspective view of molded-foam resilient cushioning member 320 that may be used in anti-fatigue mat 300. Resilient cushioning member 320 includes lead-in ramps 320A and 320B, and further includes lead-in ramps 320D and 320E that are not visible in the views of the other drawings. Resilient cushioning member 320 includes rounded corners 341, 342, 343 and 344 that facilitate insertion and removal of resilient cushioning member 320 from mat 300.

FIG. 3D is a bottom plan view of anti-fatigue mat 300 that shows receiver 310 including receiver section 310-1 and receiver section 310-2 with aperture 315 therebetween. This view also shows the serge 330 as surrounding the peripheral edge of mat 300.

FIG. 3E shows a perspective view of a fully assembled anti-fatigue mat 300 with a resilient cushioning member 320 installed therein. Lead-in ramps 305A, 305B, 305C and 305D are visible in this view. Serge 330 is also visible in this view.

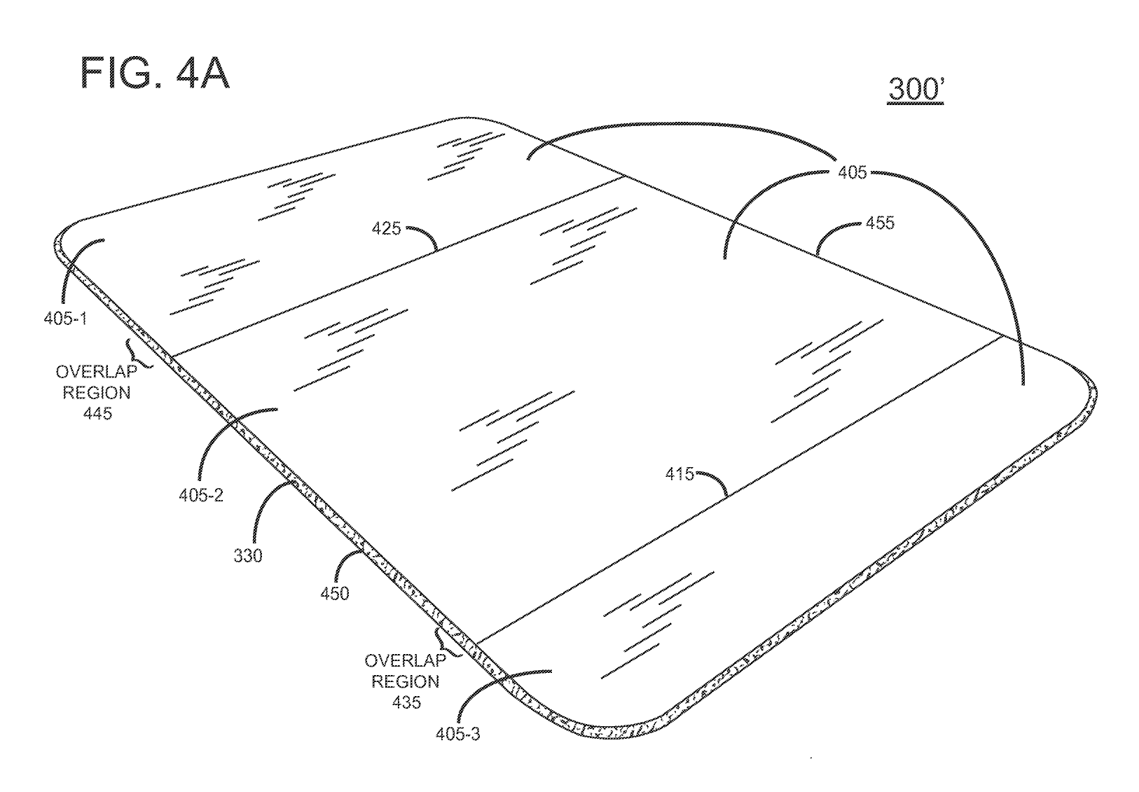

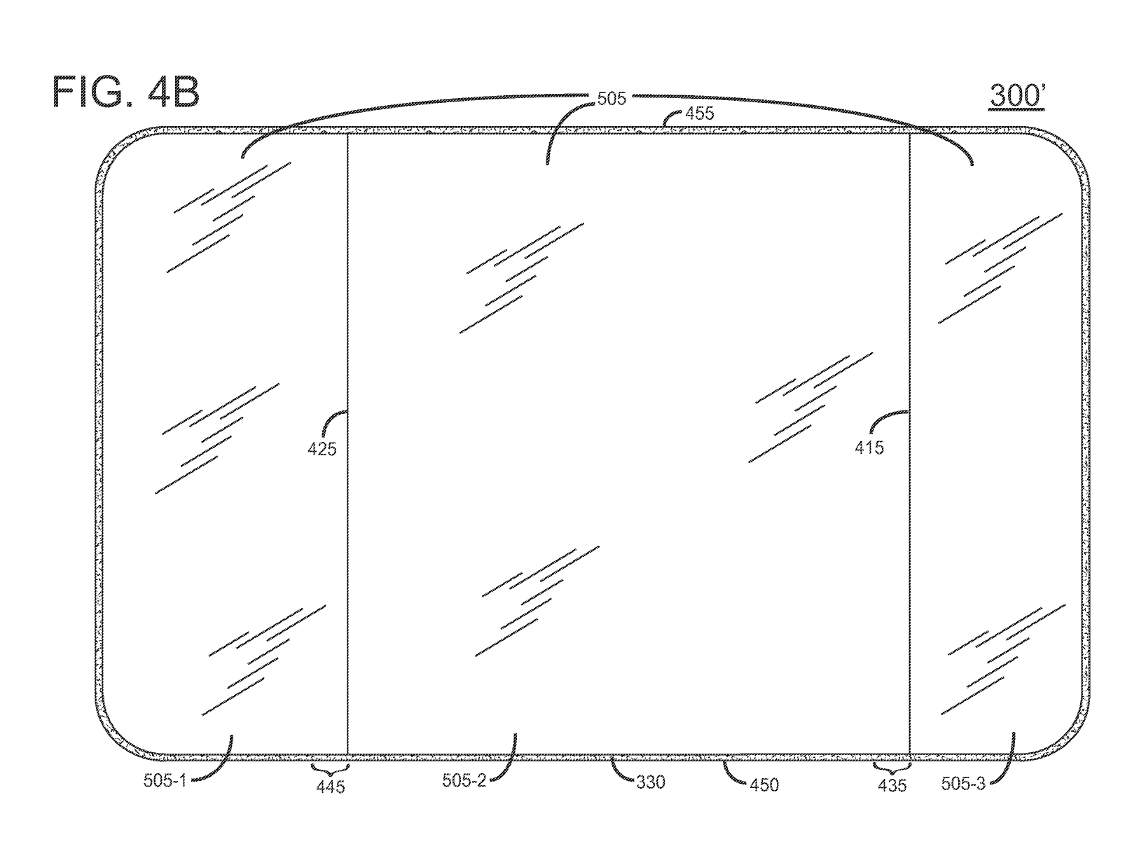

FIG. 4A shows a perspective view of an alternative embodiment of the anti-fatigue mat as anti-fatigue mat 300′. FIG. 4B shows a plan view of anti-fatigue mat 300′. As the lengthwise dimension of the anti-fatigue mat increases, it may become more difficult to install the resilient cushioning member through an aperture in the receiver. Anti-fatigue mat 300′ of FIG. 4A is similar to anti-fatigue mat 300 of FIGS. 3A-3E, except that mat 300′ may be longer than mat 300, and mat 300′ employs a receiver 405 that exhibits a different configuration than receiver 310 of mat 300.

More particularly, anti-fatigue mat 300′ includes a receiver 405 that includes receiver sections 405-1, 405-2 and 405-3. Anti-fatigue mat 300′ includes a primary opening, i.e. a primary aperture 415, between receiver section 405-2 and receiver section 405-3. The user may insert the resilient cushioning member (not shown) into primary aperture 415 between receiver section 405-2 and receiver section 405-3 to install the resilient cushioning member in anti-fatigue mat 300′. Anti-fatigue mat 300′ also includes a secondary opening, i.e. a secondary aperture 425, between receiver section 405-1 and receiver section 405-2. To install the resilient cushioning member, the user may push the resilient cushioning member into aperture 415 and pull the resilient cushioning member further into receiver 405 by accessing receiver 405 through aperture 425. To remove the resilient cushioning member from receiver 405 of anti-fatigue mat 300′, the user may reverse the above-described procedure. In one embodiment, primary aperture 415 and secondary aperture 425 extend substantially the entire distance between opposed edges 450 and 455 in the widthwise dimension of anti-fatigue mat 300′.

Anti-fatigue mat 300′ includes overlap regions 435 and 445 that are formed in substantially the same manner as overlap region 325 of anti-fatigue mat 300. Overlap region 435 is formed at aperture 415. Receiver section 405-3 overlaps receiver section 405-2 at aperture 415 to form overlap region 345. Overlap region 445 is formed at aperture 425. Receiver section 405-2 overlaps receiver section 405-1 at aperture 425 to form overlap region 445. Overlap regions 435 and 445 may perform the same functions as overlap region 325 of anti-fatigue mat 300, such as holding the mat in tension. Although not visible in FIG. 4A or 4B, a resilient cushioning member similar to resilient cushioning member 320 is installed in receiver 405 of anti-fatigue mat 300′.

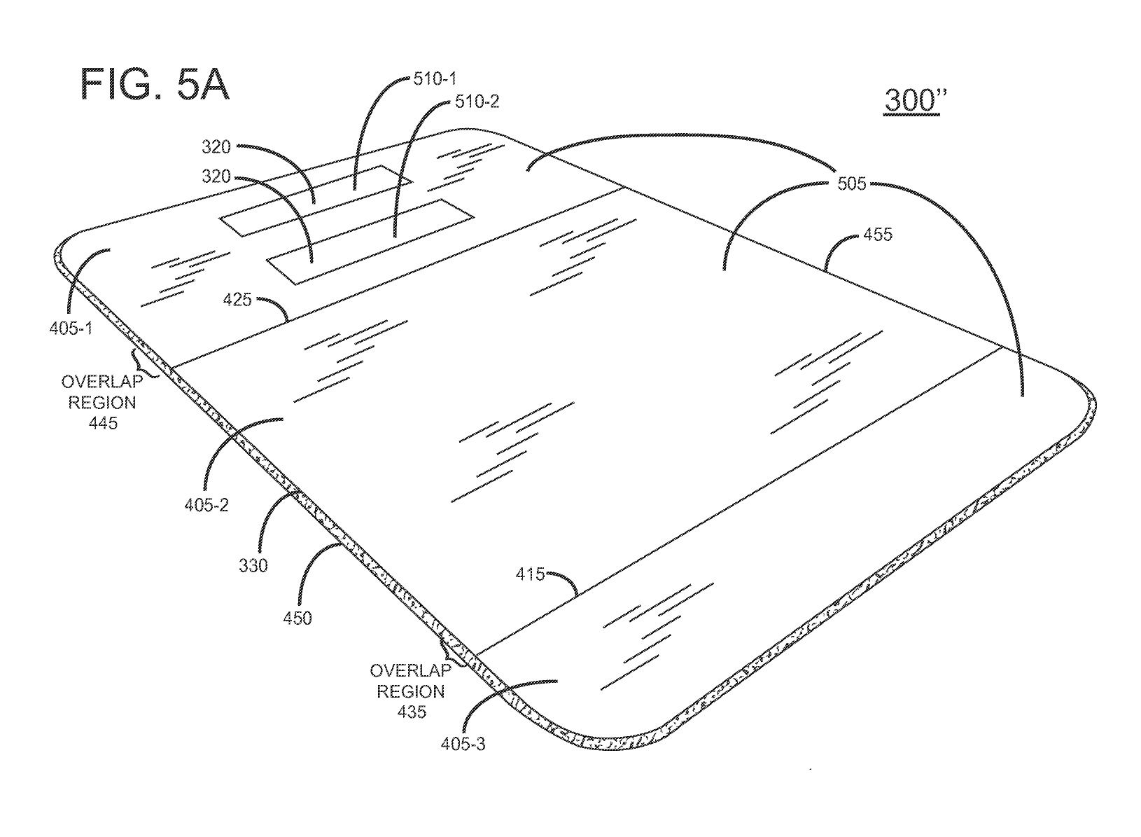

FIG. 5A shows an anti-fatigue mat 300″ that is similar to anti-fatigue mat 300′ of FIG. 4A, except that anti-fatigue mat 300″ includes one or more access openings, such as openings 510-1 and 510-2 for example. FIG. 5B shows a plan view of anti-fatigue mat 300″ with resilient cushioning member 320 visible in openings 510-1 and 510-2. In one embodiment, openings 510-1 and 510-2 exhibit a different geometry than apertures 415 and 425. For example, apertures 415 and 425 appear as a one-dimensional slit extending between the opposed edges 450 and 455 of mat 300″, whereas openings 510-1 and 510-2 exhibit a 2 dimensional geometry that extends across a portion of, but not the entirety of, the widthwise dimension between opposed edges 450 and 455. More particularly, openings 510-1 and 510-2 may exhibit a 2-dimensional geometry such as rectangular, as shown, square, circular, elliptical as well as other 2-dimensional geometries that allow the user's hand to access the interior of receiver 505. Apertures 415, 425 and openings 510-1, 510-2 may all facilitate the user's access to the interior of receiver 505 to enable the user to position resilient cushioning member 320 within receiver 505 such that the four corners of resilient cushioning member 320 extend fully to the four corners of mat 300″ interior to receiver 505. In one embodiment, opening 510-1 is centered between opposed edges 450 and 455, so as to exhibit a width approximately one third of the distance between opposed edges 450 and 455. In one embodiment, opening 510-1 may be larger than illustrated, but should not be so large as to negatively impact the structural integrity of anti-fatigue mat 300″. In another embodiment, mat 300″ may not include aperture 425. In such an embodiment, the user may access the resilient cushioning member 320 inside mat 300″ via opening 510-2 instead of aperture 425. In yet another embodiment, the mat 300″ may not include opening 510-2 and aperture 425. In such an embodiment, the user may access the resilient cushioning member 320 via opening 510-1 instead of opening 510-2 and aperture 245.

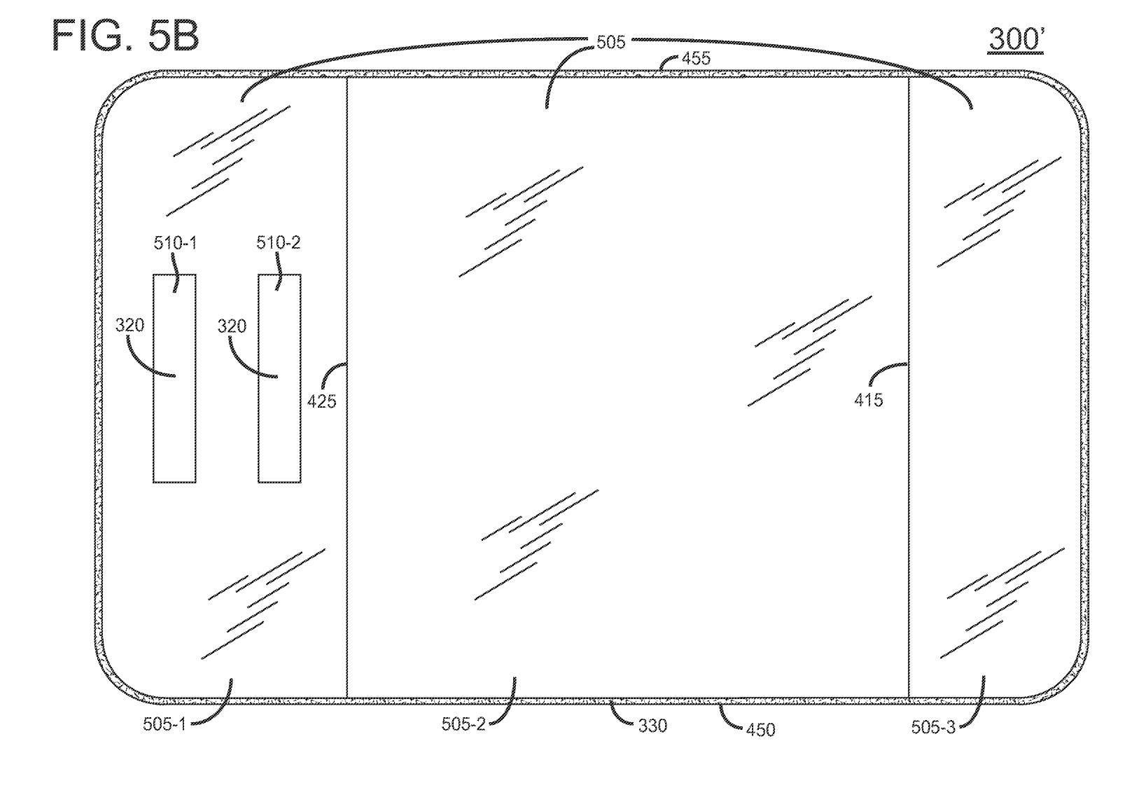

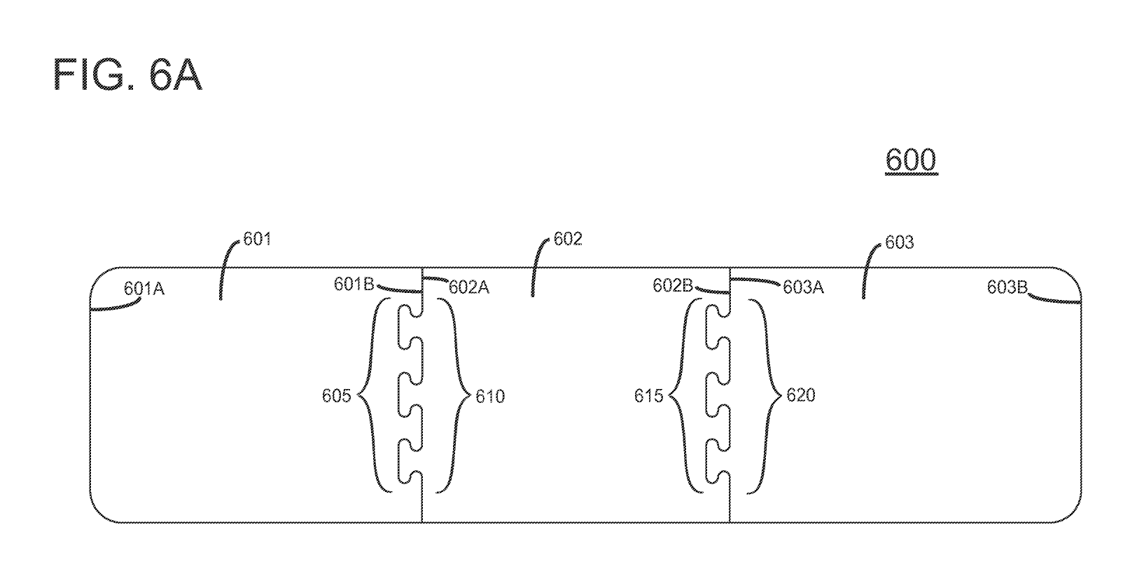

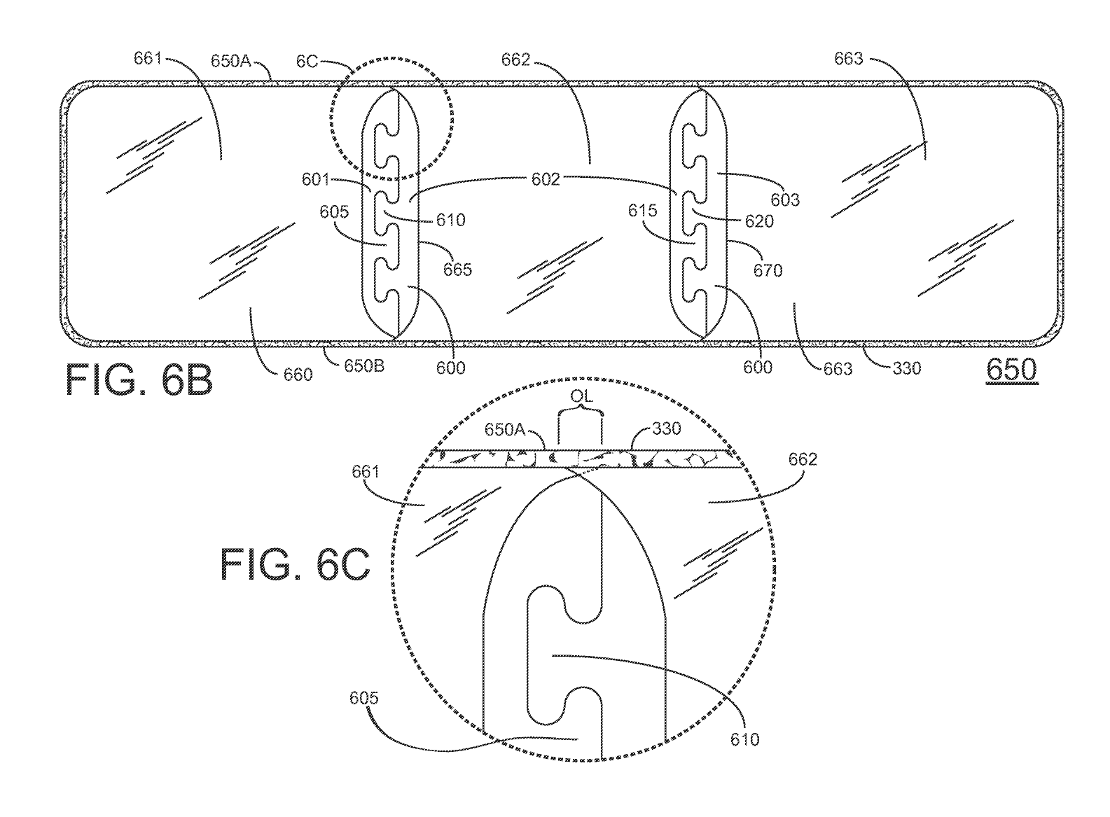

Anti-fatigue mats that are very long, such as those approximately 48 inches or longer may include multiple resilient cushioning member sections that connect together to form the entire resilient cushioning member. FIG. 6A shows such a resilient cushioning member 600 that includes resilient cushioning member sections 601, 602 and 603. Resilient cushioning member sections 601, 602 and 603 connect together in end-to-end fashion to form the long resilient cushioning member 600 that FIG. 6A depicts. Resilient cushioning member section 601 includes opposed ends 601A and 601B. Resilient cushioning member section 602 includes opposed ends 602A and 602B. Resilient cushioning member section 603 includes opposed ends 603A and 603B.

Each resilient cushioning member section, such as section 601, includes an interlocking connector that connects that section to a corresponding mating interlocking connector of an adjacent section, such as section 602, to hold each section to the other section. One type of connector that is usable as such an interlocking connector is a puzzle-piece connector, as shown in FIG. 6A. For example, resilient cushioning member section 601 includes a puzzle-piece connector 605 that mates with a complementary puzzle-piece connector 610 of adjacent resilient cushioning member section 602. Resilient cushioning member section 602 includes another puzzle-piece connector 615 that mates with a complementary puzzle-piece connector 620 of adjacent resilient cushioning member section 603. It will be appreciated that even longer resilient cushioning members may be formed by adding more resilient cushioning member sections with interlocking connectors.

Although not specifically illustrated in FIG. 6A, resilient cushioning member 600 may include lead-in ramps on its four sides in the same manner that resilient cushioning member 320 of FIG. 3C includes lead-in ramps. Die-cutting foam material is one way to form resilient cushioning member 600 with interlocking connectors.

FIG. 6B shows an assembled, long anti-fatigue mat 650 with resilient cushioning member 600 installed therein. Before installing resilient cushioning member 600 in receiver 660 of anti-fatigue mat 650, the user may assemble resilient cushioning member 600 as shown in FIG. 6A. FIG. 6B shows a plan view of the bottom of anti-fatigue mat 600 that includes a receiver 660 having receiver sections 661, 662 and 663. Receiver 660 includes an opening 665 that is positioned to make puzzle-piece connectors 605 and 610 accessible to the user during and after assembly of anti-fatigue mat 650. Receiver 660 may also include an opening 670 that is positioned to make puzzle-piece connectors 605 and 610 accessible to the user during and after assembly of anti-fatigue mat 650. Openings 665 and 670 may exhibit an oval, elliptical, scalloped or other geometry that allows receiver section 661 to overlap receiver section 662 at opposed edges 650A and 650B, as shown in the close-up view of the overlap that FIG. 6C provides. As seen in FIG. 6C, receiver section 661 overlaps receiver section 662 by an overlap distance value, OL, adjacent edge 650A. In one embodiment, the overlap value OL may be with the range of approximately 10 cm to approximately 20 cm. There is a similar overlap between receiver section 661 and receiver section 662 at the opposite edge 650B of mat 650, as shown in FIG. 6B. In a manner similar to that described above, receiver section 662 overlaps receiver section 663 adjacent opposed edges 650A and 650B at opening 670. The overlap provided in the regions designated, OL, above helps to maintain tension on mat 650 which aids in maintaining the tightness of the wear element (not shown) of the mat 650. The wear element of mat 650 is not visible in FIG. 6B because the wear element is on the side of the mat opposite that which FIG. 6B depicts. The wear element that mat 650 employs is similar to the wear element 305 shown in FIG. 3A except that the wear element is appropriately longer to accommodate the increased length of mat 650.

In one embodiment, resilient cushioning member 320 need not be fully assembled prior to installation in receiver 660 of mat 650. Referring again to FIG. 6B, the user may install resilient cushioning member section 601 in opening 665 and resilient cushioning member section 602 in either opening 665 or 670. After placing resilient cushioning member sections 601 and 602 inside of receiver 660, the user positions resilient cushioning member sections 601 and 602 adjacent one another at opening 665 such that resilient cushioning member section 601 connects to resilient cushioning member section 602, as shown. The user may insert resilient cushioning member section 603 through opening 670 and further position resilient cushioning member section 603 to connect to resilient cushioning member section 602, as shown. To disassemble anti-fatigue mat 605, the above-described procedure is reversed.

In the embodiment described above, if anti-fatigue mat 650 is folded, such as during shipping or storage, a natural bend point occurs at open regions 665 and 670 where the resilient cushioning member sections connect, as shown. This allows the assembled mat 650 to bend at openings 665 and 670 where adjacent resilient cushioning member sections connect together.

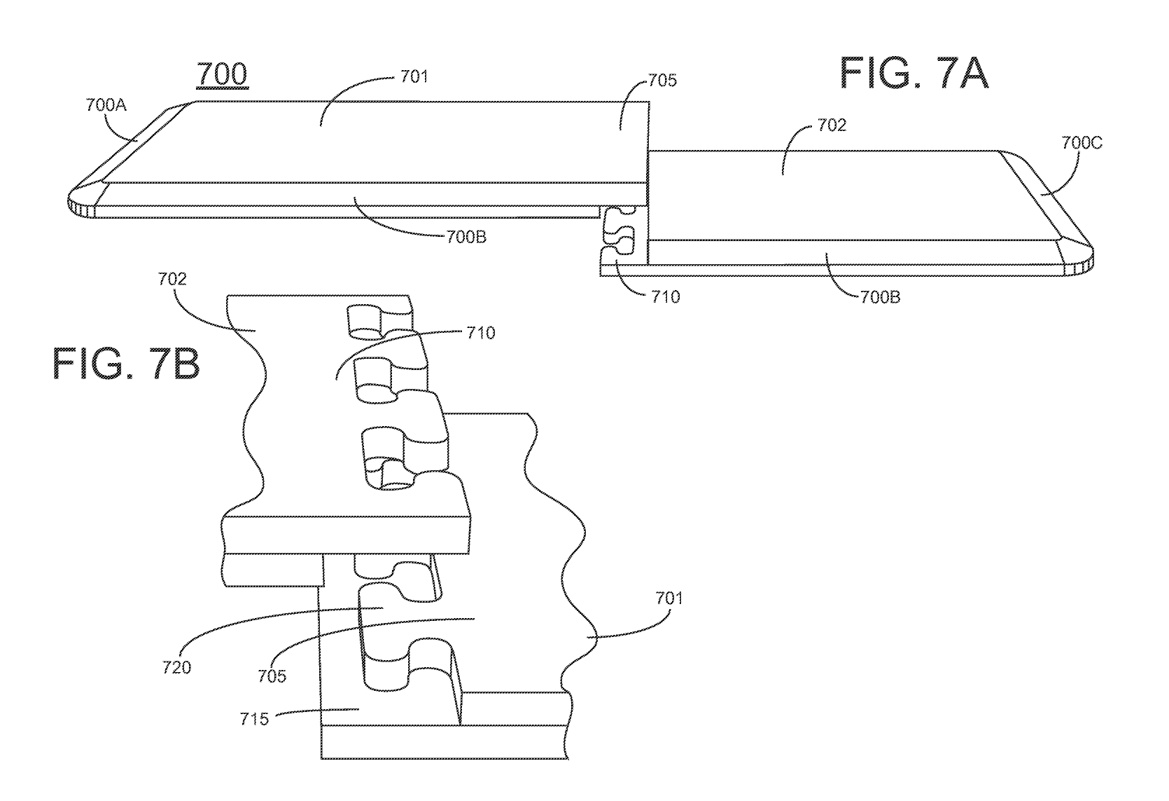

FIG. 7A shows another embodiment of the resilient cushioning member 700 that the disclosed anti-fatigue mat may employ. Resilient cushioning member 700 is a molded foam cushioning member in one embodiment. Resilient cushioning member 700 includes resilient cushioning member sections 701 and 702. Resilient cushioning member sections 701 and 702 connect together in end-to-end fashion to form the long resilient cushioning member 700 that FIG. 7A depicts. To facilitate connecting resilient cushioning member section 701 to resilient cushioning member section 702, resilient cushioning member 701 includes an interlocking connector 705 and resilient cushioning member 702 includes a corresponding interlocking connector 710. Puzzle-piece connectors may be employed as interlocking connectors 705 and 710 as shown in FIG. 7A and more clearly in FIG. 7B.

FIG. 7B shows a close-up view of the portion of resilient cushioning member 700 where resilient cushioning members sections 701 and 702 connect together. The view of FIG. 7B is rotated 180 degrees as compared with the view of FIG. 7A. As shown in FIG. 7B, resilient cushioning member section 701 includes an interlocking connector 705 that connects section 701 to an interlocking connector 710 of adjacent resilient cushioning member section 702 to hold each section to the other section. One type of connector that is usable as such an interlocking connector is a puzzle-piece connector as shown in FIG. 7B. For example, in this embodiment where a puzzle-piece connector is used as the interlocking connector, resilient cushioning member section 701 includes a puzzle-piece connector 705 that mates with a complementary puzzle-piece connector 710 of adjacent resilient cushioning member section 702. In one embodiment, one of the two puzzle-piece connectors may include a ledge on which individual connective elements of that connector sit. For example, puzzle-piece connector 705 of resilient cushioning member 701 includes a ledge 715 on which individual puzzle piece connective elements, such as element 720, are situated.

To assemble resilient cushioning member 700, a user presses puzzle-piece connector 710 into the puzzle piece connector 705 such that one mates with the other to connect resilient cushioning member section 702 to resilient cushioning member section 701. It will be appreciated that even longer resilient cushioning members may be formed by adding more resilient cushioning member sections with interlocking connectors in a manner similar to that of resilient cushioning member 600 of FIG. 6A. When fully assembled, resilient cushioning member 700 appears similar to resilient cushioning member 320 of FIG. 3C, except for a line visible where puzzle piece connectors 705 and 710 connect together. Referring again to FIG. 7A, resilient cushioning member includes 700 respective lead-in ramps similar to the lead-in ramps of FIG. 3C. For example, lead-in ramps 700A, 700B and 700C are visible in resilient cushioning member 700 of FIG. 7A. Resilient cushioning member 700 may be assembled either before or after connecting resilient cushioning member sections 701 and 702 together. Receivers similar to receiver 405 of FIG. 4A, or receiver 660 of FIG. 6B, may be used together with resilient cushioning member 700 to form an anti-fatigue mat.

The disclosed anti-fatigue mat may provide substantially increased cushioning ability in comparison with the minimal cushioning that a rug or carpet would provide alone. In one embodiment, the anti-fatigue mat provides an amply cushioned anti-fatigue capability and a nicely styled wear surface that gives a natural feeling when the user stands on the mat. Moreover, in one embodiment, when the resilient cushioning member is removed from the mat, the wear surface may be machine washable or more easily cleanable than otherwise possible.

The following discusses attributes and features of different embodiments of the disclosed anti-fatigue mat. The resilient cushioning member may be sufficiently inset from, or sufficiently spaced-apart from, the peripheral edges of the wear element to form a lead-in ramp that assists in reducing the likelihood of tripping on the edge of the mat. The receiver sections may be fabricated from non-slip materials to hold the mat in position on a floor or other surface. The receiver sections may be fabricated from a material similar to rug material, for example cotton, so that wear element and receiver shrink at the same rate when the mat is washed after removal of the resilient cushioning member. In an alternative embodiment, sections of the cushioning element may be exposed to the floor through additional openings in the receiver to provide a non-slip surface.

A number of different ways are contemplated for holding the resilient cushioning member to the wear element, wherein the wear element may be fabricated from rug-like material, such as textiles. In one embodiment, hook and loop fasteners may hold the resilient cushioning member to the wear element. Mechanical fasteners may removably hold the resilient cushioning member and the wear element together. Two short pockets may be coupled to the respective opposed ends of the wear element. In that embodiment, the resilient cushioning member bends to thread into each pocket. In one embodiment, the receiver may include a zipper at the aperture to zip a first receiver section to a second receiver section, thus holding and closing the resilient cushioning member within the receiver. In an alternative embodiment, the aperture and the zipper may be moved to other locations, such as along one long edge of the receiver. In another embodiment, safety pins molded into the resilient cushioning member may attach to the wear element. Alternatively, button-hole fasteners may fit through slots in the resilient cushioning member and may even provide another non-slip element.

In yet another embodiment, weak adhesive on the top side of the resilient cushioning member may removably hold the resilient cushioning member to the wear element. Alternatively, the resilient cushioning member and the wear element may be outfitted with magnetic material to removably hold one to the other. In another embodiment, the corners of the wear element may be outfitted with fabric corners to hold the resilient cushioning member in place on the wear element in a manner like a picture in a photo album. Alternatively, triangular flaps may fold over each edge of the resilient cushioning member and employ either a button-hole mechanism or a snap tie mechanism in the middle of the resilient cushioning member to hold the resilient cushioning member to the wear element. The resilient cushioning member may snap onto the wear element. In yet another embodiment, the receiver may snap onto the wear element. The receiver provides a cavity for holding the resilient cushioning member. In another embodiment, a hinge is formed by loops on the wear element and cushioning element, wherein a rod is passed through the loops of the wear element and the loops of the cushioning element to hold one to the other. In yet another embodiment, elastic loops on the wear element may stretch around the resilient cushioning member to hold one to the other. In still another embodiment, the resilient cushioning member is permanently attached to the wear element without a receiver by an adhesive coupling, bonding or other permanent attachment therebetween.

In yet another embodiment, the resilient cushioning member is placed in a pillow case-like member, wherein the pillow case-like member is attached to the wear element rather then being sewn. In another embodiment, gel or smooth plastic circles situated on the wear element connect with corresponding gel or smooth plastic circles situated on the cushioning element to create a static-cling connection or coupling. In another embodiment, metal hooks are molded into the resilient cushioning member to connect the resilient cushioning member to the wear element in a drapery-hook type arrangement. In still another embodiment, the wear element is outfitted with an elastic loop that goes through the wear element through a slit in the resilient cushioning member. A pin or rod extends through the elastic loop to hold the resilient cushioning member to the wear element. The rod or pin is pulled with force into the resilient cushioning member so that it does not scratch the floor or other surface. In yet another embodiment, removable staples pierce the wear element and attach to molded-in sockets in the resilient cushioning member to hold the resilient cushioning member to the wear element. In still another embodiment, clips attached to the wear element and/or resilient cushioning member hold each to the other.

in summary, in one embodiment, the disclosed anti-fatigue mat includes a “dual mode” feature and a “dual friction” feature that cooperate to provide a desirable, flexible anti-fatigue mat. The dual mode feature enables the mat to operate in a first mode with the resilient cushioning member installed inside the receiver. The mat also operates in a second mode in which the receiver of the mat does not contain the resilient cushioning member. The resilient cushioning member of the mat is removable and the mat will still function although with less cushioning effect in the second mode than with the resilient cushioning member inside the receiver in the first mode.

The disclosed anti-fatigue mat also includes a “dual friction” feature. In one aspect of the dual friction feature, the interior surface of the wear element exhibits high friction with respect to the upper surface of the resilient cushioning member. In this manner, slippage between the wear element and the cushioning member and bunching of the wear element are reduced. This occurs in the first mode wherein the resilient cushioning member is installed in the receiver of the mat. In another aspect of the dual friction feature, when the resilient cushioning member is removed from the mat such as during the second mode, the high friction interior surface of the wear element contacts the interior surface of the receiver to reduce motion between the wear element and the receiver.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An anti-fatigue mat, comprising:
a wear element including a wear surface for supporting a user;
a resilient cushioning member; and
a receiver, attached to the wear element, that receives the resilient cushioning member therein, the receiver including an aperture through which the resilient element may be installed and removed.

2. The anti-fatigue mat of claim 1, wherein the anti-fatigue mat operates in a first mode in which the resilient cushioning member is situated in the receiver.

3. The anti-fatigue mat of claim 1, wherein the anti-fatigue mat operates in a second mode in which a resilient cushioning member is not situated in the receiver.

4. The anti-fatigue mat of claim 1, wherein the resilient cushioning member is comprised of foam.

5. The anti-fatigue mat of claim 1, wherein the resilient cushioning member is comprised of gel.

6. The anti-fatigue mat of claim 1, wherein the resilient cushioning member is comprised of gel and foam.

7. The anti-fatigue mat of claim 1, wherein the wear element comprises a textile.

8. The anti-fatigue mat of claim 1, wherein the receiver is integral to the wear element.

9. The anti-fatigue mat of claim 1, wherein the receiver includes first and second receiver sections with the aperture therebetween through which the resilient cushioning member may pass.

10. The anti-fatigue mat of claim 9, wherein the first and second receiver sections are non-overlapping at the aperture.

11. The anti-fatigue mat of claim 10, wherein the first and second receiver sections are overlapped at the aperture.

12. An anti-fatigue mat, comprising:
a wear element including a wear surface for supporting a user;
a resilient cushioning member; and
a receiver, attached to the wear element, that receives the resilient cushioning member therein, the receiver including an aperture through which the resilient element may be installed and removed;
wherein the wear element includes a first mat interior surface opposed to the wear surface, the first mat interior surface of the wear element exhibiting high friction that reduces movement of the wear element relative to the resilient cushioning member when the resilient cushioning member is inside the receiver.

13. The anti-fatigue mat of claim 11, wherein the receiver includes an exterior surface and a second mat interior surface opposed to the exterior surface, wherein the second mat interior surface contacts the first mat interior surface when the resilient cushioning member is removed from the mat, the high friction exhibited by the first mat interior surface of the wear element relative to the second mat interior surface of the receiver reducing movement of the wear element relative to the receiver.

14. The anti-fatigue mat of claim 13, wherein the second mat interior surface exhibits low friction.

15. The anti-fatigue mat of claim 14, wherein the exterior surface of the receiver comprises an anti-slip surface.

16. The anti-fatigue mat of claim 12, wherein the first mat interior surface exhibits a friction sufficiently high to reduce bunching of the wear element when the wear element supports a user.

17. The anti-fatigue mat of claim 12, wherein the receiver includes an exterior surface and a second mat interior surface opposed to the exterior surface, the second mat interior surface exhibiting low friction relative to the resilient cushioning member to facilitate installation of the resilient cushioning member in the receiver or removal of the resilient cushioning member from the receiver.

18. The anti-fatigue mat of claim 12, wherein the resilient cushioning member includes rounded corners.

19. The anti-fatigue mat of claim 12, wherein the resilient cushioning member exhibits a rectangular geometry including first, second, third and fourth sides that include first, second, third and fourth cushion ramps, respectively.

20. The anti-fatigue mat of claim 19, wherein upon installation of the resilient cushioning member in the receiver, the wear element conforms to the geometry of the resilient cushioning member, such that the wear element exhibits first, second, third and fourth wear element ramps above the first, second, third and fourth cushion ramps, respectively.

21. The anti-fatigue mat of claim 12, wherein the receiver includes first and second receiver sections with a first aperture between the first and second receiver sections.

22. The anti-fatigue mat of claim 21, wherein the receiver includes a third receiver section with a second aperture between the second and third receiver sections.

23. The anti-fatigue mat of claim 22 wherein the first receiver section includes an access opening between the first aperture and a side of the first receiver section.

24. The anti-fatigue mat of claim 21, wherein the first and second receiver sections overlap at the first aperture.

25. The anti-fatigue mat of claim 12, wherein the resilient cushioning member include multiple layers exhibiting different respective durometers.

26. An anti-fatigue mat, comprising:
a wear element including a wear surface for supporting a user; and
a receiver, attached to the wear element, configured to receive a resilient cushioning member therein, the receiver including an aperture through which the resilient element may be installed and removed.

27. The anti-fatigue mat of claim 26, wherein the receiver includes an exterior surface that is an anti-slip surface that interfaces with a floor.

28. The anti-fatigue mat of claim 26, wherein the wear element includes a first mat interior surface opposed to the wear surface, the first mat interior surface of the wear element exhibiting high friction to reduce movement of the wear element relative to a second mat interior surface of the receiver when the resilient cushioning member is not in the receiver.

29. The anti-fatigue mat of claim 26, wherein the resilient cushioning member is situated in the receiver, wherein the wear element includes a first mat interior surface opposed to the wear surface, the first mat interior surface of the wear element exhibiting high friction, such that the anti-fatigue mat reduces movement of the wear element relative to the resilient cushioning member situated in the receiver.

30. An anti-fatigue mat, comprising:
a wear element including a wear surface for supporting a user;
a resilient cushioning member; and
a receiver, attached to the wear element, that receives the resilient cushioning member therein, the receiver including an aperture through which the resilient element may be installed and removed,
wherein the resilient cushioning member includes first and second resilient cushioning member sections, the first resilient cushioning member section including a first connector that connects with a second connector on the second resilient cushioning member section to hold the first resilient cushioning member section to the second resilient cushioning member section.

31. The anti-fatigue mat of claim 30, wherein the first and second connectors are puzzle-piece connectors.

32. The anti-fatigue mat of claim 30, wherein the resilient cushioning member includes rounded corners.

33. The anti-fatigue mat of claim 30, wherein the receiver includes a first receiver section and a second receiver section with an opening between the first and second receiver sections, the opening exhibiting a geometry that provides access to the resilient cushioning member for inserting the resilient cushioning member into the receiver and removing the resilient cushioning member from the receiver.

34. The anti-fatigue mat of claim 31, wherein the mat includes first and second opposed edges, and third and forth opposed edges.

35. The anti-fatigue mat of claim 34, wherein the mat includes a serge that extends along the first, second, third and forth opposed edges to connect the receiver to the wear element.

36. The anti-fatigue mat of claim 34, wherein the first and second receiver sections overlap adjacent the first and second opposed edges of the mat at the opening.

37. The anti-fatigue mat of claim 30, wherein the first resilient cushioning member section and the second resilient cushioning member section are comprised of die-cut foam.

38. The anti-fatigue mat of claim 30, wherein the first resilient cushioning member section and the second resilient cushioning member section are comprised of molded foam.
